(19) United States
(12) Patent Application Publication
(10) Pub. No.: US 2017/0048286 A1
(43) Pub. Date: Feb. 16, 2017

(54) LIVE BROADCAST SYSTEM

(71) Applicant: Takahiro ICHIHASHI, Nerima-ku, Tokyo (JP)

(72) Inventor: Takahiro ICHIHASHI, Nerima-ku, Tokyo (JP)

(21) Appl. No.: 15/307,369

(22) PCT Filed: May 1, 2014
(86) PCT No.: PCT/JP2014/062096

§ 371 Date: Oct. 28, 2016

(51) Int. Cl. H04L 29/06; H04L 29/08

(52) U.S. Cl. CPC H04L 65/403; H04L 67/104

(57) ABSTRACT

To enable a viewer to view/listen a talk among users making a bidirectional call by transmitting and receiving voice and picture in real time. A live broadcast system is provided with: live participant terminals 1 that include a camera 115 and a microphone 114 for acquiring a picture and voice of each live participant, and that receive the input of an operation signal by the live participant; a live participant communication unit 102 that performs a bidirectional call via a P2P network 5a formed by the live participant terminals 1; a broadcast screen generation unit 103a that displays, in a selectable manner, icons indicating the picture and voice being transmitted and received by the bidirectional call by the live participant communication unit 102, and that generates a broadcast screen for outputting the picture and voice related to each icon in accordance with a selection operation; a content delivery unit 223a that delivers the broadcast screen via the communication network 5; and viewer terminals 3 that are respectively used by predetermined viewers and that receive and output the broadcast screen via the communication network 5.

### TECHNICAL FIELD

The present invention relates to a live broadcast system which broadcasts, to the viewer, for example, a talk among users making a bidirectional call by transmitting and receiving voice and picture on a real time base.

### BACKGROUND ART

Conventionally, there are communication systems for communication among remote users such as telephones, so-called video telephones, video conference systems and the like. In addition, there are techniques for enabling text chatting, video chatting with pictures and voice and the like on the basis of data communication through the Internet with personal computers connected to the Internet.

For example, the technique disclosed in Patent Document 1 is a video chatting system which is provided with a group formation means for forming a chatting group and a voice line connection means for enabling a voice communication among members of a group formed by the group formation means to realize a video communication among members of the group formed by the group formation means through the voice line connection means.

### PRIOR ART DOCUMENTS

### Patent Documents

[Patent Document 1]
Japanese Patent Published Application No. 2003-6129

### SUMMARY OF THE INVENTION

### Problems to be Solved by the Invention

However, in the case of the video chatting technique disclosed in Patent Document 1 enabling a bidirectional call by transmitting and receiving voice and picture on a real time base, a closed area is formed on the basis of a “calling” operation to an intended recipient and a “responding” operation at the recipient end so that, for example, outsiders cannot view/listen a talk among predetermined users by the use of the video chatting technique, and thereby there is a problem that it is difficult for the talkers to performs presentation and information transmission to a group including unknown persons.

Accordingly, the present invention has been made in the circumstances as described above. It is an object of the present invention to provide a live broadcast system in which, while a caller performs “live participation” or “standby operation” under a URL which is defined by a user for each user and each topic, an incoming call receiver is allowed to view/listen a talk and the state of the caller without requiring a response operation to promote the diversification of broadcast forms and content.

### Means for Solving Problem

In order to accomplish the object as described above, the present invention is characterized in that there are provided: a live participant terminal used by each of particular live participants, provided with an input device which acquires video and audio of the live participant, and configured to receive an operation signal of the live participant; a live participant communication unit configured to perform a bidirectional call by transmitting and receiving video and audio acquired with the input device on a real time base through a first communication network formed by the live participant terminals; a graphic interface control unit configured to generate icons designating video and audio transmitted and received during the bidirectional call performed by the live participant communication unit; a broadcast screen generation unit configured to display the icon in order that the icon can be selected by an operation signal of the live participant, and generate a broadcast screen for outputting video and audio corresponding to each icon in response to a selection operation by the operation signal; a broadcast screen delivery unit configured to deliver the broadcast screen through a second communication network; a viewer terminal used by each of predetermined viewers and configured to receive and output the broadcast screen.

In this case, the first communication network includes a peer-to-peer network system based on OLM (OverLay Multicast), and the second communication network is a network which is separated from the first communication network but may operate in accordance with the same communication architecture (communication protocol, communication layers) as the first communication network or in accordance with a different communication architecture than the first communication network.

In accordance with the present invention as described above, the live participant communication unit performs a bidirectional call by transmitting and receiving video and audio data acquired with the input device on a real time base through the first communication network formed by the live participant terminals, and thereby a viewer can view/listen the broadcast screen including video and audio of a talk among the live participant terminals by generating the broadcast screen in which is output video and audio transmitted and received during a bidirectional call, and transmitting and outputting the broadcast screen through the second communication network to the viewer terminal used by each viewer.

Particularly, in the case of the present invention, since the broadcast screen generation unit displays icons designating video and audio transmitted and received during a bidirectional call in order that the icons can be selected by an operation signal of a live participant, and outputs video and audio corresponding to each icon in response to a selection operation by the operation signal, it is possible to perform a talk by viewing presentation, video and audio attracting attention displayed over the entire screen, and the partner's face at the same time, switch the broadcast by a gesture operation on an icon, and therefore lessen the burden that the broadcast screen is operated by the user himself.

In the case of the above invention, it is preferred to provide a manager terminal configured to control the bidirectional call and delivery through the first communication network and the second communication network, and that the broadcast screen generation unit is provided with a manager operation unit configured to control the output of video and audio corresponding to each icon in response to an operation signal from the manager terminal. In this case, since the output of video and audio corresponding to each icon is controlled by the manager terminal which controls the bidirectional call and delivery, for example, a group talk can smoothly be progressed by applying a right to speak to a predetermined live participant and prohibiting the other live participants from speaking during that time to prevent a plurality of live participants from speaking at the same time.

In the case of the above invention, it is preferred to provide a connection managing unit configured to acquire a permission signal from the live participant terminal or the manager terminal, and permit the viewer terminal to connect with the first communication network on the basis of the permission signal which is acquired, and that the live participant communication unit is provided with functionality to have the viewer terminal permitted by the connection managing unit participate the bidirectional talk as the live participant terminal. In this case, it is possible to encourage a viewer viewing/listening the live broadcast to actively participate the live broadcast, and therefore attract interests in the live broadcast to increase the number of participants in the service of this system.

### Effects of the Invention

As has been discussed above, in accordance with the present invention, it is possible to allow a viewer to view/listen a talk among users performing a bidirectional call by transmitting and receiving audio and video on a real time base.

### BRIEF DESCRIPTION OF THE DRAWINGS

FIG. 1 is a schematic representation showing the overall configuration of a system in accordance with the first embodiment.

FIG. 2 is a block diagram for showing the inside configuration of a management server in accordance with the first embodiment.

FIG. 3 is an explanatory view for showing the data configuration of various databases in accordance with the first embodiment.

FIG. 4 is a block diagram for showing the internal configuration of a live participant terminal in accordance with the first embodiment.

FIG. 5 is a block diagram for showing the internal configuration of a viewer terminal in accordance with the first embodiment.

FIG. 6 is an explanatory view for showing the display form of a broadcast screen in accordance with the first embodiment.

FIGS. 7A to 7F are explanatory views for showing the display form of a terminal having a large size screen in accordance with the first embodiment. In the explanatory figures, FIGS. 7A to 7D show channel screens displayed on a live participant terminal, and FIGS. 7E and 7F show channel screens displayed on a viewer terminal.

FIGS. 8A to 8E are explanatory views for showing the display form of a delivery terminal having a small size screen in accordance with the first embodiment. In the figures, FIGS. 8A to 8D show channel screens displayed on a live participant terminal, and FIG. 8E shows a channel screen displayed on a viewer terminal.

FIGS. 9A to 9D are explanatory views for showing the outline of operation in a delivery terminal in accordance with the first embodiment.

FIG. 10A is a sequence flow chart showing the operations from creating a talk group to a viewing/listening participation request in accordance with the first embodiment.

FIG. 10BA is a sequence flow chart showing the operations from starting delivery to starting conversation in accordance with the first embodiment, and FIG. 10BB is a sequence flow chart showing the operations relating to a live participation request during conversation in accordance with the first embodiment.

FIG. 11 is a sequence flow chart showing the operation of a viewer who views/listens conversation of a talk group in accordance with the first embodiment.

FIG. 12 is an explanatory view for showing computer readable mediums which store a program in accordance with the first embodiment.

FIG. 13 is a block diagram for schematically showing the configuration of the system in accordance with a second embodiment.

FIG. 14 is a block diagram for showing the internal configuration of the management server in accordance with the second embodiment.

FIG. 15 is a block diagram for showing the internal configuration of a viewer terminal in accordance with the second embodiment.

FIG. 16 is a sequence diagram for showing the content delivery process to a viewer terminal in accordance with the second embodiment.

FIG. 17 is a schematic representation showing the overall configuration of the system in accordance with a third embodiment.

FIG. 18 is a block diagram for showing the internal structure of a management server in accordance with the third embodiment.

FIGS. 19A and 19B are explanatory views for showing display forms in a broadcast screen in accordance with the third embodiment.

FIG. 20A is an explanatory view for showing a pop-up window of a play list in accordance with the third embodiment, and FIG. 20B is an explanatory view for showing a data structure of the play list.

### MODE FOR CARRYING OUT THE INVENTION

### First Embodiment

### Outline of the Live Broadcast System

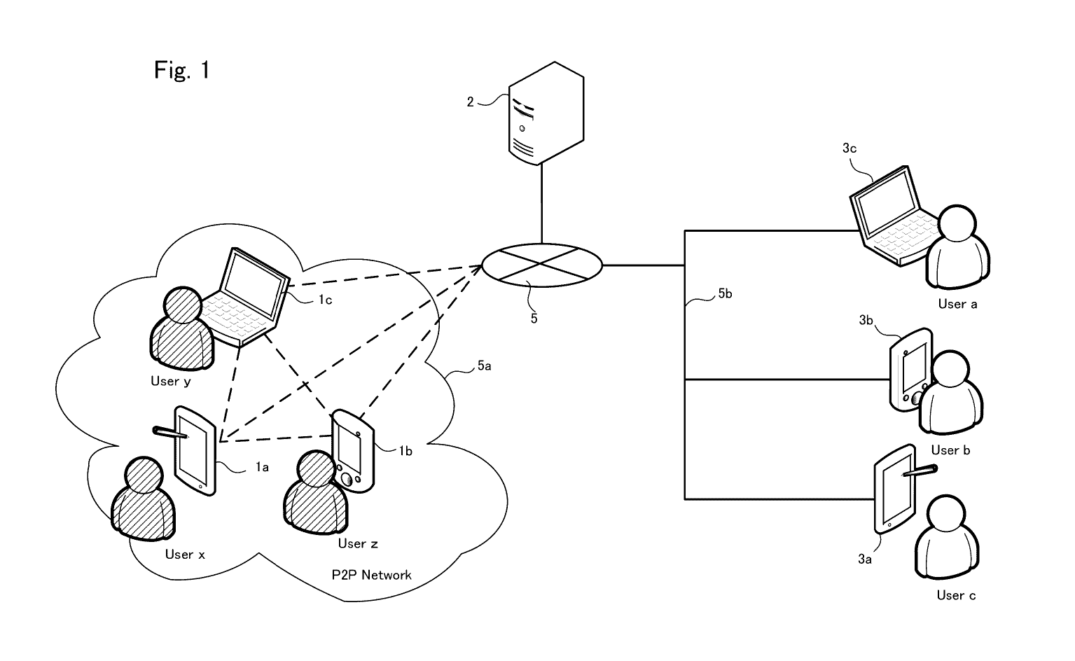

In what follows, with reference to the accompanying drawings, a first embodiment of a live broadcast system in accordance with the present invention will be explained in detail. FIG. 1 is a schematic representation showing the overall configuration of the live broadcast system in accordance with the present embodiment.

As illustrated in FIG. 1, the live broadcast system of the present invention includes a management server 2 which is located in a communication network 5 and to which a plurality of live participant terminals 1a to 1c are connected to form a virtual group (channel) through communication among the plurality of live participant terminals 1a to 1c and enable live chatting within the virtual group. Then, the live broadcast system delivers a broadcast screen including audio data and video data generated on the basis of the talk in the group to other viewer terminals 3a to 3c connected to the communication network 5.

The above virtual group of the present invention is given URLs which are easy to remember and assigned to be used as links to the area where the live chatting is provided. Specifically speaking, linking is promoted in existing search engines, SNSs and the like to increase the number of accesses by forming URLs such as http://<user name>.<domain name> assigned to each user and http://<user name>.<domain name>/<topic name> based on a topic.

Meanwhile, the present embodiment will be explained in an exemplary case where a user x using the terminal 1a of the live participant terminals 1a to 1c creates the group (channel) in which users y and z participate as particular live participants. Also, in what follows, the terminal used by the user x is referred to as the manager terminal 1a, and the live participant terminals 1a to 1c are collectively referred to as the live participant terminal 1 when making no distinction among them. Incidentally, while the user x is the manager and the other users y and z are participants in this example, either of the other users y and z can be the manager and the user x can be a participant.

Furthermore, in the case of the present embodiment, users a, b and c are viewers who view the broadcast through the channel but do not participate in the talk. The terminals used by the users a, b and c are referred to as the viewer terminals 3a to 3c, and the viewer terminals 3a to 3c are collectively referred to as the viewer participant terminal 3. However, the users a, b and c can participate in the group after viewing the content, and in such a case the users a, b and c become live participants and the terminals used by the users a, b and c are referred to the live participant terminals 1.

The communication network 5 is a distributed IP network built by using the communication protocol TCP/IP and connecting a variety of communication lines (optical lines such as FTTH lines, public lines such as ADSL lines, dedicated lines, and wireless communication networks) with each other. This IP network includes LANs such as intranets (in-enterprise networks) and home networks on the basis of 10BASE-T and 100BASE-TX. Also, in the case of the present embodiment, the communication network 5 is the so-called Internet. This Internet 5 comprises the usual Internet 5b corresponding to “a second communication network” of the present invention and a so-called P2P (peer-to-peer) network 5a corresponding to “a first communication network” of the present invention. The manager terminal 1a and the live participant terminals 1b and 1c are located on the P2P network 5a. On the other hand, the viewer terminals 3a to 3c are located on the communication network 5b as the second communication network. Incidentally, this first communication network can use a full-mesh type P2P which can form a P2P network among the viewers of each group on the basis of an OLM network when the terminal devices are located in an environment where P2P communication is possible. Conversely, when the terminal devices are located in an environment where P2P communication is not possible, the usual unicast Internet is used as the second communication network.

The live participant terminal 1 and the viewer terminal 3 are information processing terminals which are provided with arithmetic processing functionality by CPUs and communication processing functionality by communication interfaces, and can be implemented for example as portable telephone terminals such as smartphones, general purpose personal computers such as personal computers, functionally specialized dedicated devices, mobile computers and PDAs (Personal Digital Assistances). Meanwhile, in the case shown in FIG. 1, the terminals 1c and 3c are general purpose personal computers such as personal computers, the terminals 1b and 3b are devices provided with functionality of a portable information terminal such as a smartphone, a mobile phone and the like, and the terminals 1a and 3a are tablet terminals provided with communication functionality of a portable information terminal and having a large-sized display unit.

These live participant terminal 1 and viewer terminal 3 are provided with a browser function for accessing the Internet to transmit and receive data. The browser function is implemented by application software for viewing/listening Web pages by downloading HTML (HyperText Markup Language) files, image files and music files, and parsing layouts to display/reproduce the Web pages. It is also possible for users to transmit data to a Web server through a form, and run application software written in JavaScript (registered trademark), Flash, Java (registered trademark) and so forth.

Furthermore, in the case of the present embodiment, the live participant terminal 1 and viewer terminal 3 are provided with functionality for receiving delivery of broadcast screens including content data through the Internet or the like, and functionality for running an application for viewing/listening this content data. This “content data” includes audio data and text data of conversation exchanged through a plurality of live participant terminals 1, and picture data of still images and videos taken by the camera of each live participant terminal 1.

Particularly, the live participant terminal 1 is provided with functionality which makes it possible to share content data downloaded by one of the live participant terminals 1a to 1c with the other live participant terminals 1a to 1c through the P2P network 5a so that content data can be delivered to each other among the distributed terminals. Each live participant terminal 1 is provided with functionality of a node server which establishes direct connection with a found node, or directly transmits and receives data through a relay node without intervention of the management server 2.

Incidentally, of the live participant terminals 1, the manager terminal 1a used by the user x, who is the manager, is provided with functionality for controlling bidirectional calling and delivery through the P2P network 5a and the communication network 5, and controlling the delivery of content data, e.g., the start and end of broadcasting. In addition to this, the manager terminal 1a may function as a super node which records and searches user names, IP addresses, port numbers and other information of the other live participant terminals 1.

The management server 2 is an ordinary communication server which is distributedly arranged in the communication network 5 to form a virtual channel through communication among the plurality of terminals and deliver content through the virtual channel to the other viewer terminals 3a to 3c. This management server 2 includes a Web server which is implemented as a server computer or software having functionality for transmitting information such as HTML (HyperText Markup Language) files, image files and music files in a document system such as WWW (World Wide Web) to accumulate information such as HTML documents and images and deliver content (Web pages) in response to a request of an application such as a Web browser running on the live participant terminal 1 and the viewer terminal 3.

The management server 2 is provided also with functionality as a content delivering server for delivering content, which is created, to the viewer terminal 3 for example in a motion picture format. This management server 2 is connected with a database and provided also with functionality for managing users. Meanwhile, in the case of the present embodiment, this management server 2 is implemented with a single server device. However, this management server 2 may be implemented with a group of a plurality of servers, for example, a node management server (group conversation control unit), a conversion server for transcoding and Web servers together with a load balancer which serves to load balance these servers.

Furthermore, although not shown in the figure, wireless base stations and relay devices are arranged in the communication network 5. The wireless base stations are connected with the communication network through the relay devices in order to establish wireless communication connections with the live participant terminal 1 and provide conversation and data communication. The relay devices are node devices such as modems, terminal adapters, gateway apparatuses and the like, and serve to perform relay operation between the wireless base stations and the communication network 5 by selecting communication routes and performing interconversion of data (signals). Incidentally, these wireless base stations and relay devices include wireless routers and access point devices and the like.

(Inside Configuration of Each Device)

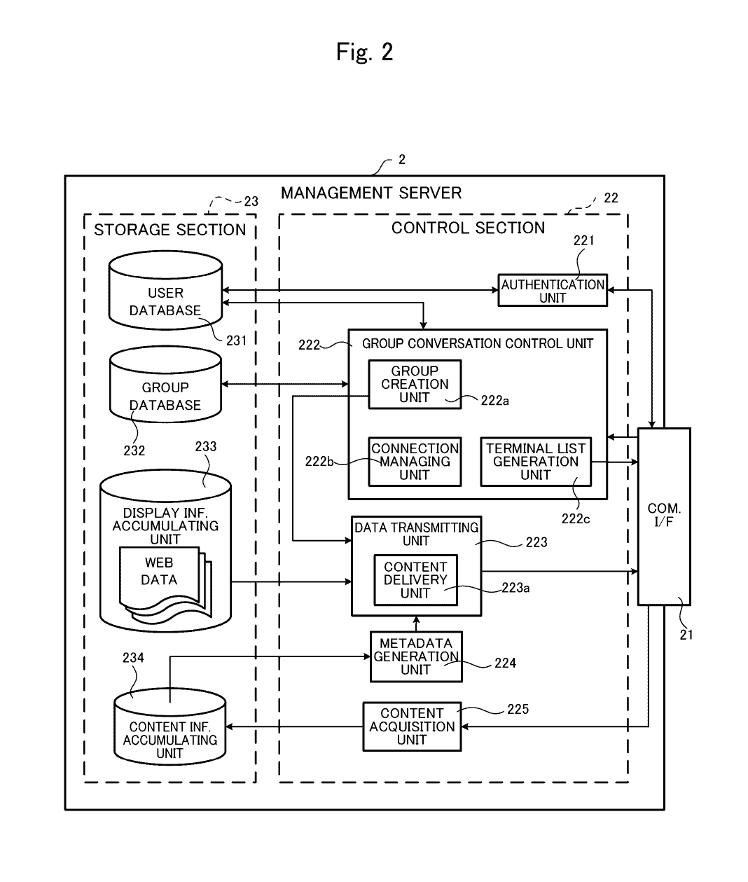

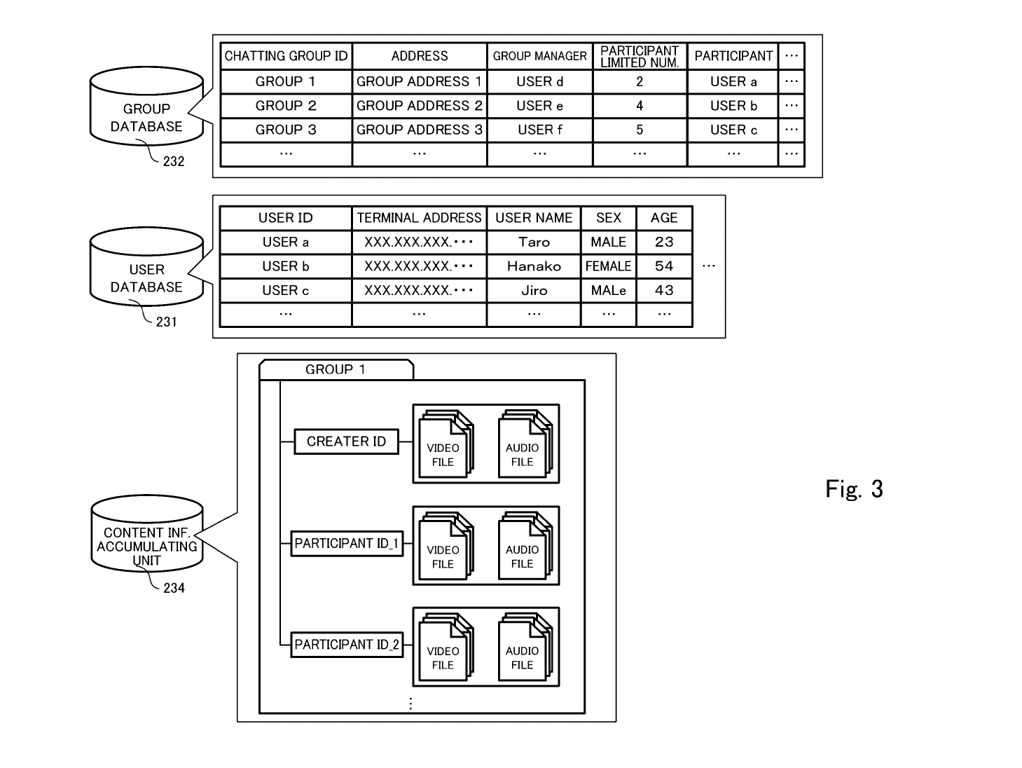

Next, the inside configuration of each device of the above live broadcast system will be explained. FIG. 2 is a block diagram for showing the inside configuration of the management server 2 in accordance with the present embodiment. FIG. 3 is an explanatory view for showing the data configuration of various databases in accordance with the present embodiment. Incidentally, the term “module” used in this explanation is intended to encompass any function unit capable of performing necessary operation, as implemented with hardware such as a device or an apparatus, software capable of performing the functionality of the hardware, or any combination thereof.

(1) Management Server 2

First, the functional configuration of the management server 2 will be explained. The management server 2 can be implemented as a single server device, or alternatively as a server group consisting of a plurality of servers such as Web servers and database servers. In the case of the present embodiment, as shown in FIG. 2, the management server 2 is provided with a communication interface 21, a control section 22, a storage section 23 as a database group for accumulating various types of information relating to the live broadcast system. The communication interface 21 is a communication interface for performing data transmission and reception to/from the live participant terminals 1 and the viewer terminals 3 through the communication network 5.

The storage section 23 is a storage apparatus for accumulating various data and provided with a user database 231, a group database 232, a display information accumulating unit 233 and a content information accumulating unit 234 in the case of the present embodiment. The user database 231 is a database for storing information about users who use the live broadcast system, and in the case of the present embodiment, as shown in FIG. 3, IP addresses of the live participant terminals 1 and the viewer terminals 3 and personal information (user name, gender, age and so forth) are accumulated in association with user IDs for identifying users.

The group database 232 is a database for accumulating conversation groups of a plurality of live participant terminals 1 which can be used for multicall and accumulating IP addresses of groups, user IDs of managers who create the groups, participation limited numbers, and user IDs which identify the participants participating in the groups in association with group IDs which identify the groups respectively. In the case of the present embodiment, this group may be created in response to a group creation request from the live participant terminal 1, or may be created by the operator who operates and manages the management server 2.

Furthermore, in addition to this, the group database is used to save location information (=option) which is set by the manager, and the ID/URL of content which is reproduced in the center/entirety of the screen of the group. The aforementioned location information can be used, when live broadcast is associated with the current place, for service utilization and future effective data transmission as a customer attraction means in the place where the live broadcast is performed. Also, the above ID/URL can be used for displaying presentation and videos in a screen, and viewing/listening the same content together with persons located in remote places.

The content information accumulating unit 234 is a storage device for accumulating content which is created by a talk among the plurality of live participant terminal 1 within a group. In the case of the present embodiment, the folder of a group ID is associated with the user ID of each delivering user, and audio data and video data of the each delivering user is accumulated in association with the user ID of the each delivering user.

The display information accumulating unit 233 is a storage device for accumulating Web data which is display information, and accumulating display data such as Web pages corresponding to connection requests manipulated/operated by a delivering user and Web pages which are viewed/listened by viewers. Incidentally, the display information accumulating unit 233 accumulates display information in association with group IDs and can create a background image and a channel image specific to each group.

The control section 22 is an arithmetic operation module composed of hardware elements, for example, processor(s) such as a CPU and a DSP (Digital Signal Processor), a memory, and other necessary electronic circuits, software such as programs for implementing necessary functions of the hardware elements, or combination thereof. Several function modules can be virtually implemented by loading and executing the programs so that a variety of processes is performed by the implemented function modules in response to the operation by the user.

Then, this control section 22 includes an authentication unit 221, a group conversation control unit 222, a data transmitting unit 223, a metadata generation unit 224 and a content acquisition unit 225.

The authentication unit 221 is a module for performing an authentication process on the basis of a user ID which is acquired through the communication network 5, and confirming whether or not an accessing user has an access right, whether or not the accessing user is identified and the like by referring to the user database 231 in response to an access by the live participant terminal 1 or the viewer terminal 3. Meanwhile, in the case of the present embodiment, the authentication unit 221 may ask an accessing user to input an ID and a password each time when accessing, or may give authentication only with terminal information if the user has consented in advance.

The group conversation control unit 222 is a module for managing the overall control of group talks, and performs creation of a group (channel) and connection process of the live participant terminals 1. Specifically, the group conversation control unit 222 is provided with a group creation unit 222a, a connection managing unit 222b, and a terminal list generation unit 222c.

The group creation unit 222a is a module for creating a group in which a plurality of users can participate in response to a group creation request signal from the live participant terminal 1. The group creation unit 222a assigns a group ID to the created group and register the user ID acquired of the live participant terminal 1 issuing the group creation request in a group manager list. Furthermore, the group creation unit 222a sets a participation limited number in the group database 232 on the basis of input information from the live participant terminal 1.

The connection managing unit 222b is a module for accepting a request for group participation from a live participant terminal 1, and registering the live participant terminal 1 in a group. Specifically, when accepting a request signal for group participation from the live participant terminals 1b and 1c, the connection managing unit 222b refers to the group database 232 and registers the user ID in a participant list of the database.

Also, the connection managing unit 222b is provided with the functionality to accept a request for group participation from a viewer terminal 3 and register the viewer terminal 3 in the group as a live participant terminal. Specifically, when receiving a request for group participation from the viewer terminal 3, the connection managing unit 222b transmits this group participation request to the live participant terminal 1b or 1c or the manager terminal 1a. Then, when acquiring an accept signal from the live participant terminal 1b or 1c or the manager terminal 1a, the connection managing unit 222b refers to the group database 232, registers the user ID of the viewer terminal 3 in the participant list of the database, and permits the viewer terminal 3 to connect with the first communication network on the basis of the acquired accept signal.

The terminal list generation unit 222c is a module for creating a terminal list which is a list in which are written live participant terminals 1 which transmit and receive content data within a group. Specifically, the terminal list generation unit 222c generates a terminal list in which are written the user IDs of the live participant terminals 1 participating in a group, and socket references to these terminals. When receiving a broadcast start signal from the live participant terminal 1, this terminal list generation unit 222c extracts the user IDs written in the participant list of the group database 232, refers to the user database 231 on the basis of the extracted user IDs, extracts socket references corresponding to the extracted user IDs, generates a terminal list, and transmits the terminal list to the live participant terminal 1. Incidentally, when the connection managing unit 222b permits the viewer terminal 3 to participate a group, the viewer terminal 3 is set as the live participant terminals 1b and 1c, and the user IDs of the live participant terminals 1b and 1c are also written in the terminal list and transmitted.

The content acquisition unit 225 acquires audio data and video data from each live participant terminal 1, converts audio data and video data to content data and then accumulates the content data the content information accumulating unit 234. In the case of the present embodiment, on the basis of the request content of the live participant terminal 1 which is a transmission source, the content acquisition unit 225 extracts the group ID of the group which the live participant terminal 1 participates. The content acquisition unit 225 accumulates the content data in association with the group ID.

Incidentally, this content data is acquired (captured) from each live participant terminal 1 as individual video data (raw data). Then, the content acquisition unit 225 performs encoding such as modulation, decoding, compression and the like to convert the data into data for delivery, and stores the data for delivery in the content information accumulating unit 234. Incidentally, the raw data contains time information generated in the live participant terminal 1, and the content data is arranged in the order of playback time on the basis of this time information.

Incidentally, the AAC format or the Opus format can be used as the method of encoding audio data, and the H.264 format, the VP8 format, the VP9 format or the like can be used as the method of encoding video data. Furthermore, the encoding method can be switched in accordance with the environment of the live participant terminal 1 and the viewer terminal 3. For example, the MPEG audio format, the LPCM format, the ATRAC format, the WMA format or the like can be used for audio encoding, and the MPEG-1 format, the MPEG-2 format, the MPEG-4 format, the DivX format, the WMV format, the HEVC format or the like can be used for video encoding.

The metadata generation unit 224 is a module for generating metadata of content data accumulated in the content information accumulating unit 234. This metadata contains information (attributes of the channel, explanation text and the like) about the group, reproduction times and the path (address information) to the content information accumulating unit 234. Meanwhile, in the case of the present embodiment, URLs which are easy to remember based on an identity or topics are used as the names or IDs of the groups and links to the area where the live chatting is provided. This promotes sharing in existing search engines, SNSs and the like to increase the number of accesses.

The data transmitting unit 223 is a module for delivering various data, and has functionality as a broadcast screen delivery unit, for example, to transmit display information (Web data) accumulated in the display information accumulating unit 233 to the live participant terminal 1 and the viewer terminal 3, and deliver part of a broadcast screen and metadata generated by the metadata generation unit 224 to the viewer terminal 3 which transmits a viewing/listening request signal through the communication network 5. Incidentally, the data transmitting unit 223 successively delivers the generated metadata to the viewer terminal 3 in the order of the reproduction times.

Also, the data transmitting unit 223 is provided with a content delivery unit 223a. In the case of the present embodiment, the content delivery unit 223a is a module for extracting content data in the content information accumulating unit 234 and delivering the content data to the viewer terminal 3 when receiving an access based on the path of metadata accumulated in the viewer terminal 3. In the case of the present embodiment, the viewer terminal 3 and the management server 2 constantly maintain connections, and the data transmitting unit 223 transmits the generated metadata on a real time base. When obtaining this metadata, the viewer terminal 3 then downloads the content data designated by the metadata via the http protocol and performs continuous reproduction.

(2) Live Participant Terminal 1

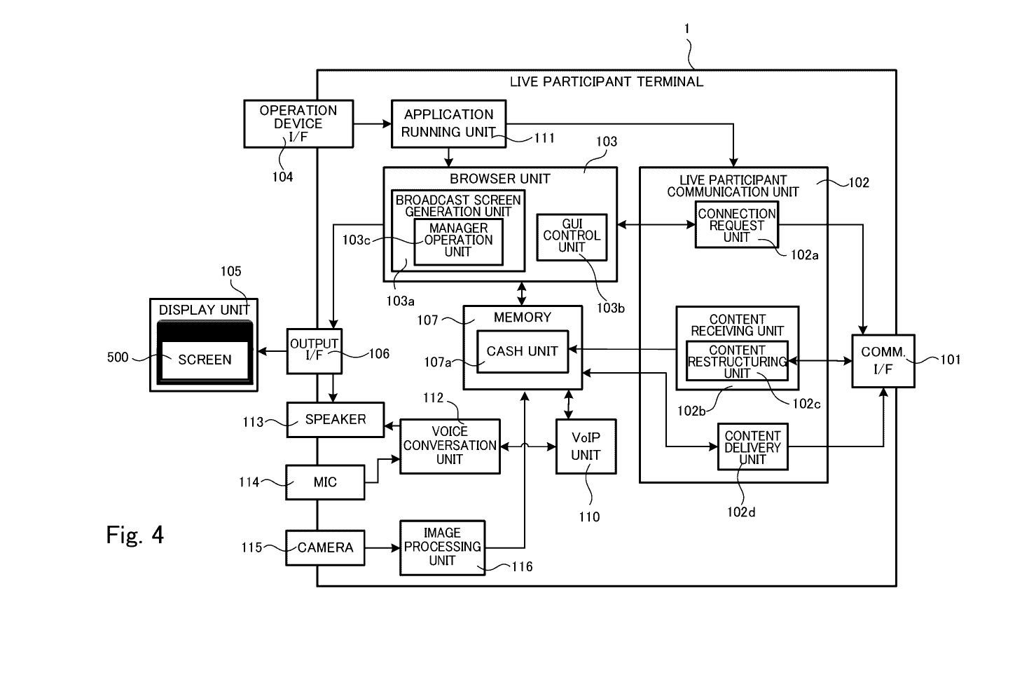

Next, the live participant terminal 1 will be explained. FIG. 4 is a block diagram for showing the internal configuration of the live participant terminal 1 in accordance with the present embodiment. The live participant terminal 1 is provided with a communication interface 101 as a communication interface base module, and a live participant communication unit 102. The communication interface 101 is a module for transmitting and receiving data as packets through the communication network 5. In the case of the present embodiment, the live participant terminal 1 communicates with the management server 2 through this communication interface 101 to transmit and receive a terminal list, participation/connection request signals and the like, and communicates with other live participant terminals 1 to transmit and receive a delivery request and content data.

The live participant communication unit 102 is a module for performing a bidirectional call by transmitting and receiving video and audio data acquired with a camera 115 and a microphone 114 as input devices on a real time base through the P2P network 5a formed by the live participant terminals 1. Specifically, the live participant communication unit 102 is provided with a content receiving unit 102b, a content delivery unit 102d and a connection request unit 102a.

The connection request unit 102a is a module for referring to the terminal list, selecting another live participant terminal 1 in the group, transmitting a connection request and a delivery request for content data to the selected terminal. Incidentally, when transmitting a delivery request, the connection request unit 102a can designate a communication mode on the basis of the viable communication modes of the terminal written in the terminal list.

The content receiving unit 102b is a module for receiving content data, which is received by the communication interface 101, in order to receive Web data from the management server 2, receive part or all of content data from another live participant terminal 1, and store the data to a memory 107.

In this case, the content receiving unit 102b is provided with a content restructuring unit 102c. The content restructuring unit 102c is a module for restructuring part or all of content data transmitted from another live participant terminal 1 in accordance with a network system configuration of the so-called OLM system (peer-to-peer), and the restructured content data is transmitted to a cash unit 107a.

The content delivery unit 102d is a module for delivering video data captured by the camera 115 and audio data input through the microphone 114 to the other live participant terminals 1 and the management server 2. In the case of the present embodiment, the content delivery unit 102d delivers part or all of content data to a plurality of live participant terminals 1 performing a talk in accordance with the terminal list, and also transmits the content data to the management server 2. Meanwhile, in the case of the present embodiment, the content delivery unit 102d also transfers content data, which is acquired from another live participant terminal 1, to other live participant terminals 1 which requests delivery.

Furthermore, in advance of delivering content data, the content delivery unit 102d may embed the identification information of the client into the content data in accordance with the digital watermarking technique or the like. This identification information of the client may, for example, be the product ID of the live participant terminal 1 or an application, an IP address, a user ID or the like. Meanwhile, in the case of the present embodiment, the live participant communication unit 102 is provided with functionality to have a viewer terminal 3 participate a bidirectional talk as the live participant terminal 1 when permitted by the connection managing unit 222b of the management server 2 so that a broadcast screen containing content data is transmitted and received by controlling the content receiving unit 102b, the content delivery unit 102d and the connection request unit 102a.

The memory 107 is a ROM device which stores programs and data of an OS (Operating System) and various applications, including the terminal list transmitted from the management server 2 and the like. Incidentally, this memory 107 is provided with a cash unit 107a. The cash unit 107a is a buffer device for temporarily accumulating part or all of content data transmitted from another live participant terminal 1 in accordance with a network system configuration of the so-called OLM system (peer-to-peer). In the case of the present embodiment, the content data acquired in response to a delivery request is downloaded and stored in the cash unit 107a in advance of performing content reproduction by a broadcast screen generation unit 103a.

The data stored in this cash unit 107a can be shared with other live participant terminals 1 in accordance with a peer-to-peer network system based on OLM (OverLay Multicast). When a delivery request is transmitted from another live participant terminal 1, the data is transmitted to this another live participant terminal 1.

Furthermore, the live participant terminal 1 is provided with, as modules for reproducing/manipulating content, an application running unit 111, an operation device interface 104, a browser unit 103 and an output interface 106.

The application running unit 111 is a module for running a general OS, browser software, and applications such as a media viewing application, and usually implemented with a CPU and the like. Meanwhile, in the case of the present embodiment, for example, the browser unit 103 is virtually implemented in the CPU by running the browser software with this application running unit 111, and the broadcast screen generation unit 103a is virtually implemented in the CPU by running the media viewing application with this application running unit 111. The browser software is software for displaying a Web page accumulated in the management server so that it is viewable by downloading HTML (HyperText Markup Language) files, image files and the like through the Internet and parsing the layouts of the files to display and reproduce the files.

Furthermore, the media viewing application is a program by which functionality to download and reproduce content data is implemented in the live participant terminal 1, and for example a real-time communication application such as WebRTC (Web Real-Time Communication) is used as the media viewing application. The downloaded content data is reproduced to output an image through the display screen of the display unit 105.

The operation device interface 104 is a module connected with operation devices such as a mouse, a touch panel and the like for receiving operation signals. The user x can perform an operation for starting a group talk with the application running unit 111 and these operation devices, and the live participants and viewers can receive relevant services such as searching for channels which they want to view.

The browser unit 103 is implemented by running the browser software as a module for viewing/listening Web pages by downloading HTML (HyperText Markup Language) files, image files and the like, and parsing layouts to display/reproduce the Web pages. Incidentally, it is also possible for users to transmit data to the management server 2 through a form, and run application software written in JavaScript (registered trademark), Flash, Java (registered trademark) and so forth.

Then, the browser unit 103 is provided with a GUI control unit 103b and the broadcast screen generation unit 103a. The GUI control unit 103b is a module for controlling a graphic user interface (GUI) which is arranged in a window 500 of the display unit 105 to display a screen relating to a group talk and accept user operation. Particularly, in the case of the present embodiment, icons or the like designating video data and audio data transmitted and received during a bidirectional call through the communication interface 101 are generated in the broadcast screen of the window 500, and operation with the icons displayed in the broadcast screen is received by the operation device interface 104 through the GUI, followed by transmitting the operation signal to the modules. The operation through the GUI is performed to create a channel, request to participate in and exit from an existing channel, and switch the channel. Incidentally, various icons displayed in the broadcast screen of the display unit 105 will be described below.

The broadcast screen generation unit 103a is a module for displaying screen display information in the broadcast screen of the display unit 105 to display icons designating video and audio transmitted and received during a bidirectional call in order that the icons can be selected by an operation signal of a live participant, and generate a broadcast screen for outputting video and audio corresponding to each icon in response to a selection operation by the operation signal. The screens generated by the broadcast screen generation unit 103a include, for example before a live broadcast, a channel screen only for the manager terminal 1a, and a channel screen generated by the manager terminal 1a for the live participant terminals 1b and 1c. Also, when a live broadcast is going on, the broadcast screen generation unit 103a displays a broadcast screen 530 in which the live participant terminals 1 participate as illustrated in FIG. 6. This broadcast screen 530 displays a plurality of icons 531 which indicate live participants and in which are displayed the faces of the live participants imaged by the cameras of the terminals, graphics set during member registration or the like.

Also, the broadcast screen generation unit 103a outputs content data associated with an icon 531, which is selected, through the cash unit 107a in response to the control signal from the application running unit 111 and the operation device interface 104, displays an image in the broadcast screen of the display unit 105 in order that the image data is embedded in a reproduction screen of Web data, and outputs audio through the speaker 113.

Furthermore, the broadcast screen generation unit 103a is provided with the manager operation unit 103c as a module provided specific to the manager terminal 1a. This manager operation unit 103c controls output of video and audio corresponding to each icon in response to an operation signal from the operation device interface 104 of the manager terminal 1a. When output of video and audio is restricted by the operation signal, video and audio corresponding to each ion is not output from the live participant terminals 1b and 1c even when the live participant inputs an operation signal.

The output interface 106 is a module for outputting video and audio output signals through the display unit 105 and the speaker 113 respectively. The display unit 105 is, for example, a display device such as a liquid crystal display to display images, letters and the like through a window which is created by an application such as browser software. The speaker 113 is an output device which outputs sounds corresponding to audio signals and audio files, and in the case of the present embodiment the speaker 113 receives audio data acquired from the other live participant terminals 1 and outputs voice of each user.

Furthermore, the live participant terminal 1 is provided with a voice conversation unit 112, a VoIP unit 110 and an image processing unit 116 as modules relating to generation/delivery of content data. The voice conversation unit 112 is a module for performing usual conversation by transmitting and receiving voice signals to transmit, to the communication network 5, a voice signal corresponding to voice input through the microphone 114 which is an input device receiving voice of the manager or a live participant and output voice through the speaker 113 of a receiver in correspondence with a voice signal which is received through the communication network 5.

The VoIP unit 110 is a module for implementing an Internet telephone on the basis of the VoIP technique. The VoIP function is to convert the voice signal input through the voice conversation unit 112 into IP packet data, transmit the IP packet data to the live participant terminal 1 as the conversation partner, convert IP packet data received from the live participant terminal 1 as the conversation partner into voice signal, and input the voice signal to the voice conversation unit 112.

The image processing unit 116 is a module for performing conversion of image data and the like required for image display to perform digital signal processing specific to image processing, and in the case of the present embodiment the image processing unit 116 performs compression encoding of still and motion image data of a delivering user taken with the camera 115 which is an input device for acquiring video of the manager or a live participant, stores the compression encoded video (image) data in the memory 107 under the control of the application running unit 111, expands and decodes the compression encoded video data and the like stored in the memory 107, and transmits the video data through the data line after expanding and decoding to the display unit 105 which then displays the video data. In this case, the video data stored in the memory 107 includes, in addition to video data taken with the camera 115, video data taken from another live participant terminal 1 and acquired through the Internet.

Then, the display unit 105 displays not only the owner of the terminal taken with the camera 115, but also other delivering users participating in the group talk in suitable positions of the broadcast screen. Incidentally, the image processing unit 116 is provided also with an image formation control function to control color conversion for converting image data to an RGB image as a display image, switching the image data and so forth, and control the overall process of image formation in the display unit 105.

The camera 115 is an imaging device which takes a still image or a motion image, and consists of lenses and a solid-state imaging device which is a CCD to focus light representing an object image on the light receiving surface of the CCD and transmit the image data to the image processing unit 116 through a camera signal processing circuit, an A/D converter and the like. This image data includes a motion image and a still image. Motion image data consists of a succession of continuous images which are transmitted as frames in a streaming format.

(3) Viewer Terminal 3

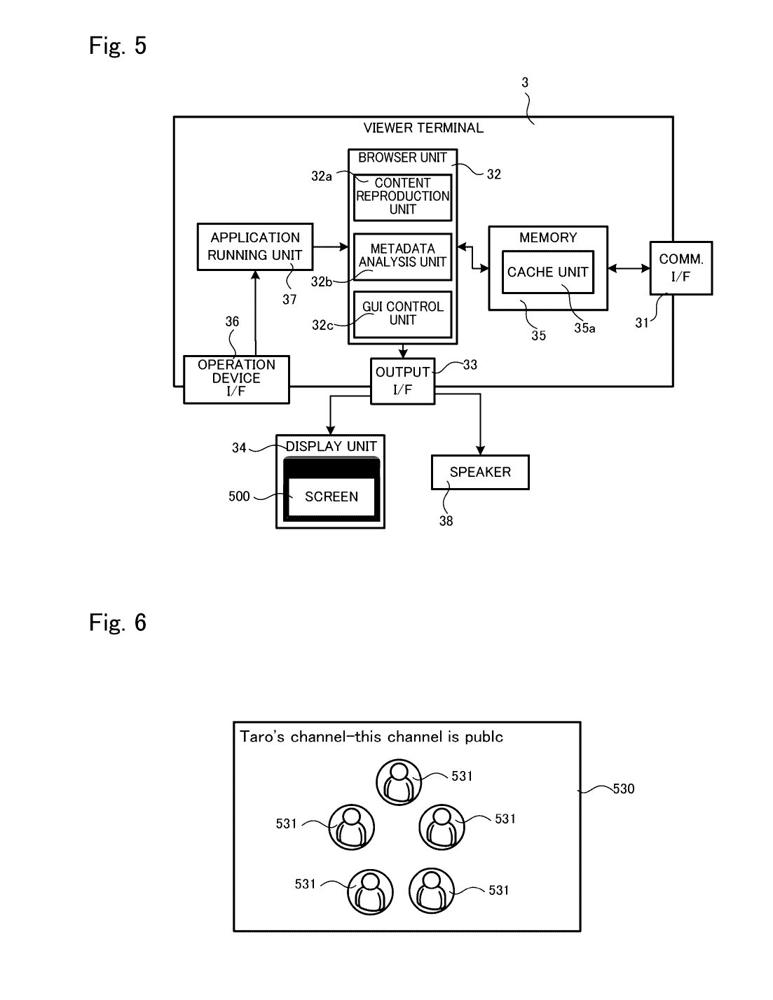

Next, the viewer terminal 3 will be explained. FIG. 5 is a block diagram for showing the internal configuration of the viewer terminal 3 in accordance with the present embodiment. As illustrated in FIG. 5, the viewer terminal 3 is provided with a communication interface 31, a memory 35, an application running unit 37, an output interface 33, a browser unit 32, an operation device interface 36.

The communication interface 31 is a module for transmitting and receiving data as packets through the communication network 5 to receive a broadcast screen including metadata and content data from the management server 2 through the communication network 5 and this communication interface 31, and transmit a Web page request, a viewing/listening request and the like to the management server 2.

The memory 35 is a storage device which stores programs and data of an OS (Operating System) and various applications, and temporarily accumulates metadata and content data, which forms a broadcast screen, transmitted from the management server 2. This memory 35 is provided with a cash unit 35a. The cash unit 35a is a buffer device which temporarily accumulates part or all of content data transmitted from the management server 2, and in the case of the present embodiment, the content data acquired by accessing in accordance with the metadata which is acquired from the management server 2 is downloaded and stored in the cash unit 35a in advance of performing content reproduction by a content reproduction unit 32a.

The output interface 33 is a module for outputting video and audio output signals through the display unit 34 and the speaker 38 respectively. The display unit 34 is, for example, a display device such as a liquid crystal display to display images, letters and the like through a window which is created by an application such as browser software. The speaker 38 is an output device which outputs sounds corresponding to audio signals and audio files, and in the case of the present embodiment the speaker 38 receives audio data acquired from the other live participant terminals 1 and outputs voice of each user.

The operation device interface 36 is a module connected with operation devices such as a mouse, a keyboard and the like for receiving operation signals through operation buttons, a touch panel and the like. A user can perform various operations for displaying a Web page and content through this operation device interface 36.

The application running unit 37 is a module for running a general OS, browser software, and applications such as a media viewing application, and usually implemented with a CPU and the like. Meanwhile, in the case of the present embodiment, the content reproduction unit 32a is virtually implemented in the CPU by running browser software and a media viewing application with this application running unit 37 in the same manner as described above.

The browser unit 32 is implemented by running the browser software as a module for viewing/listening Web pages by downloading HTML (HyperText Markup Language) files, image files and the like, and parsing layouts to display/reproduce the Web pages. In the case of the present embodiment, the browser unit 32 receives and reproduces Web data (channel list screen, and channel screens of groups) relating to channels of groups, which can be viewed/listened, by accessing the management server 2. Incidentally, it is also possible for users to transmit data to the management server 2 through a form, and run application software written in JavaScript (registered trademark), Flash, Java (registered trademark) and so forth.

This browser unit 32 is provided with a metadata analysis unit 32b, the content reproduction unit 32a, and a GUI control unit 32c. The metadata analysis unit 32b is a module for analyzing metadata received from the management server 2, extracting the access address of content data contained in the tag data, and downloading the content data from the access address.

The GUI control unit 32c is a module for controlling a graphic user interface (GUI) which is located in the broadcast screen of the display unit 34 and displays a screen relating to a group talk, and receives user operation. In the case of the present embodiment, operation with the objects displayed in the broadcast screen of the display unit 34 is received by the operation device interface 36 through the GUI, followed by transmitting the operation signal to the modules. The operation of this GUI is performed to start and end the viewing/listening of a channel and switch the channel. The operation is acquired through the operation device interface 36.

The content reproduction unit 32a is software which reproduces content data downloaded by the metadata analysis unit 32b. Specifically, the content reproduction unit 32a displays image data in the broadcast screen of the display unit 34 by a control signal from the application running unit 37 and the operation device interface 36 in order that the image data is embedded in a Web page reproduced by the browser unit 32, and outputs audio through the speaker 38.

Meanwhile, in the case of the present embodiment, the viewer terminal 3 and the management server 2 constantly maintain connections, and the metadata analysis unit 32b receives the generated metadata on a real time base. As soon as acquiring this metadata, the metadata analysis unit 32b downloads content data designated by the metadata via the http protocol and continuously reproduces the content data.

(4) Display Relating to the Broadcast Screen of the Display Units 105 and 34, and the Outline of Operation.

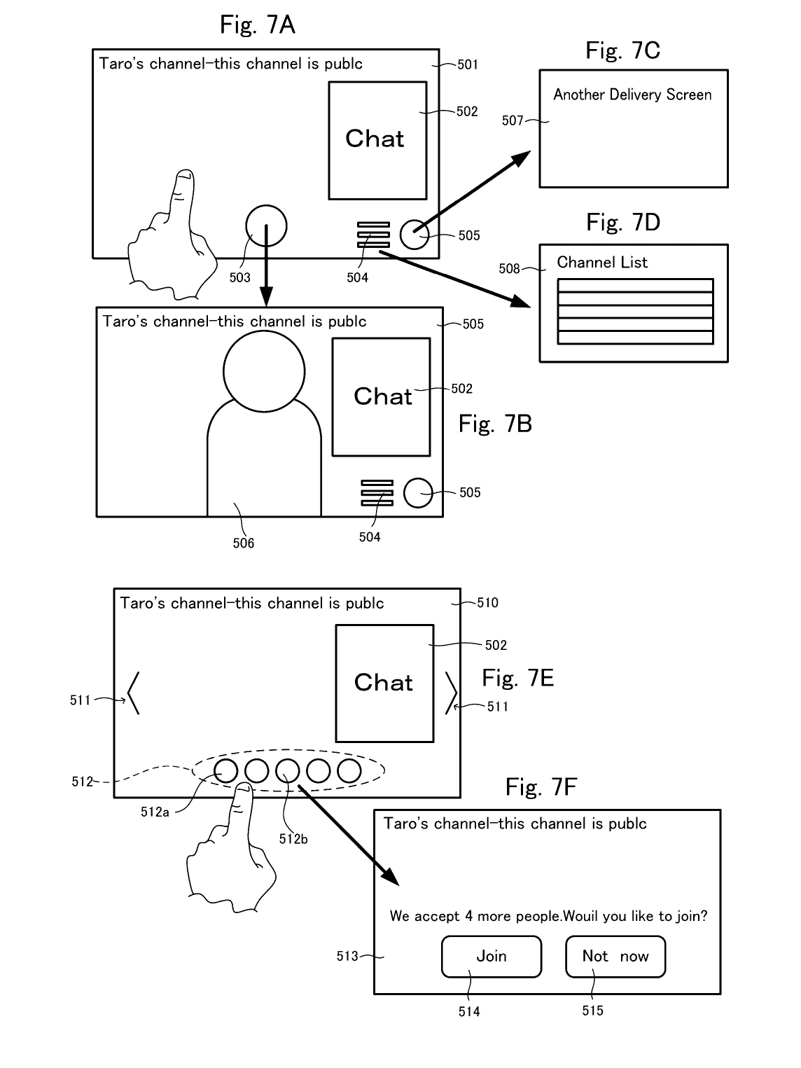

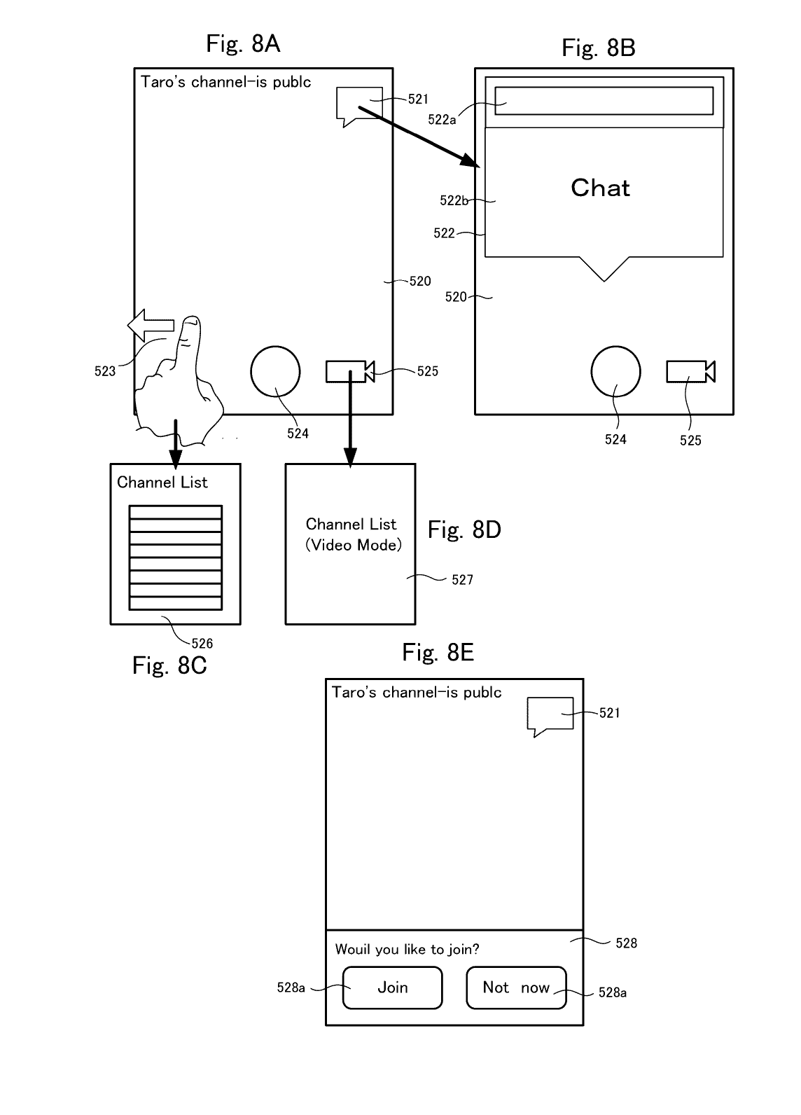

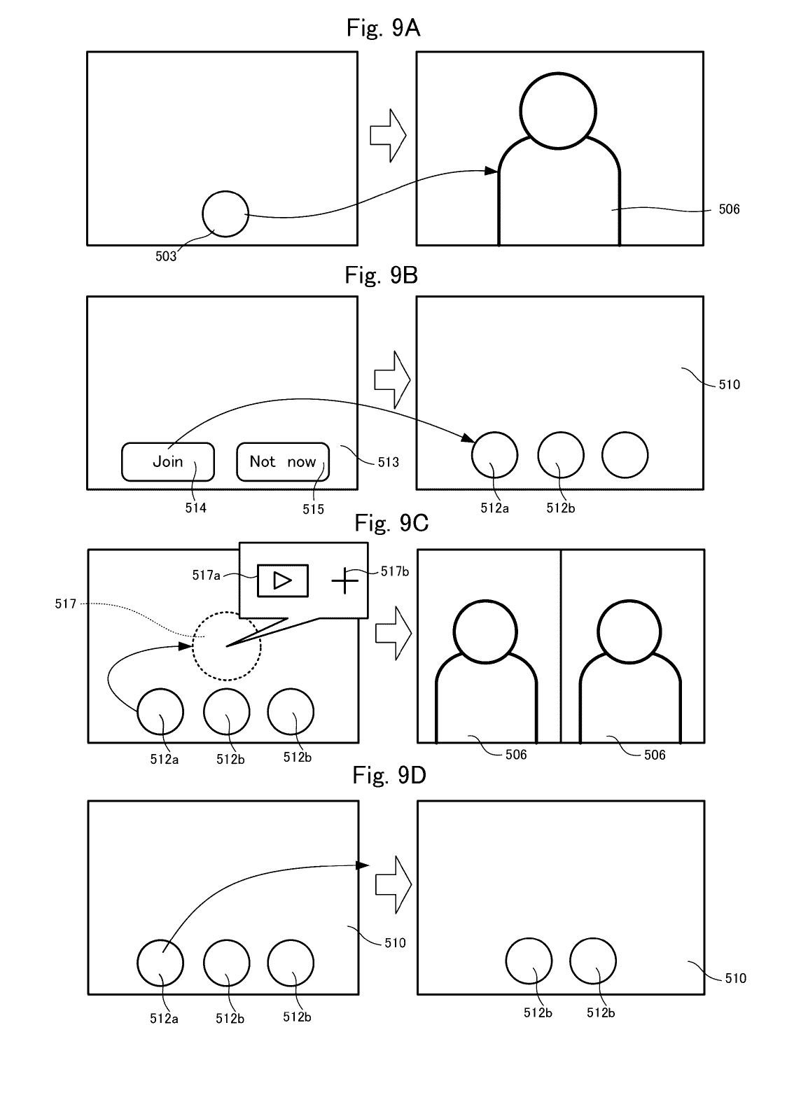

Next is an explanation of the display form of the broadcast screen displayed in the display unit 105 or 34 of the live participant terminal 1 or the viewer terminal 3, and the outline of operation. FIGS. 7A to 7F are explanatory views for showing the display form of a terminal having a large size screen. In the figures, FIGS. 7A to 7D show channel screens displayed on the live participant terminal 1, and FIGS. 7E and 7F show channel screens displayed on the viewer terminal 3. On the other hand, FIGS. 8A to 8E are explanatory views for showing the display form of a terminal having a small size screen. In the figures, FIGS. 8A to 8D show channel screens displayed on the live participant terminal 1, and FIG. 8E shows a channel screen displayed on the viewer terminal 3. Also, FIGS. 9A to 9D are explanatory views for showing the outline of operation in the screen in accordance with the present embodiment. Incidentally, the present embodiment will be explained with a terminal having a touch panel screen as an example.

First, explanation is directed to the display form for the live participant terminal 1c and the viewer terminal 3c, which are general purpose personal computers such as personal computers, and the display form for the live participant terminal 1a and the viewer terminal 3a, which are tablet terminals. As illustrated in FIG. 7A, when the process of creating a group is performed to the management server 2, a home screen 501 for live participant is displayed on the live participant terminals 1a and 1c. This home screen 501 includes “user name+channel” in the upper left corner of the screen and a chatting screen 502 in the right side. The chatting screen 502 consists of a text input box and an area in which is displayed text data which is input by other users. The home screen 501 also includes a delivery start icon 503 in the lower center, and a channel list icon 504 and a further delivery channel icon 505 in the lower right of the screen.

In this case, when the delivery start icon 503 is tapped (or clicked) by user operation as illustrated in FIG. 9A, the camera 115 of the live participant terminal 1 is activated to start taking a picture of the owner of the live participant terminal 1. Then, as illustrated in FIG. 7B and FIG. 9A, the photographed image 506 is displayed in the entirety of the screen with the interface such as the chatting screen 502 which is superimposed over the photographed image.

On the other hand, when the channel list icon 504 is tapped, a channel list screen 508 is displayed as illustrated in FIG. 7D. When any entry of this list is tapped, the screen is switched to a channel screen 507 opened by another live participant as illustrated in FIG. 7C. The users x, y and z can thereby be a manager or a participant in accordance with the group. Incidentally, this other channel screen 507 shown in FIG. 7C has the similar display form as shown in FIG. 7A.

On the other hand, when the viewer terminal 3a or 3c accesses the management server 2 and selects a predetermined channel, the channel screen 510 of the manager is displayed as illustrated in FIG. 7E. In this case, the channel name and the chatting screen 502 are displayed in the viewer terminal 3a or 3c in the same manner as described above. Also, switch icons 511 and 511 are displayed in the right and left of the channel screen 510 for switching to other channels. The screen can be switched to the channel screen 510 of another manager by tapping either icon. Furthermore, participant icons 512 are displayed in the lower center of the channel screen 510. The same number of circular icons as the participants are displayed as the participant icons 512 as illustrated in FIG. 7E. The participant icon to which a participant has been assigned is filled with a predetermined color. Conversely, the participant icon 512b to which a participant is not assigned yet is filled with, for example, white. Alternatively, the face of the participant imaged by the camera of the terminal, graphics set during member registration or the like may be displayed in the participant icon 512a to which a participant is assigned.

If the channel which is displayed is a channel in which a viewer can participate, as illustrated in FIG. 7F, a screen 513 is displayed to confirm whether to participate in this channel. The screen 513 includes a “Join” icon 514 to decide participation and a “Not now” icon 515 to decide nonparticipation. When the “Join” icon 514 is selected, the viewer terminal 3a or 3c participates in the group, followed by filling the participant icon 512a with a color as illustrated in FIG. 9B or displaying the graphic of the participating user in the participant icon 512a. Thereafter, as illustrated in FIG. 9C, the image 506 of each participant is displayed in the screen to start a talk by double clicking the own participant icon on the terminal 1 of the manager or participant or performing drag-and-drop of the participant icon 512a on a delivery start icon 517. On the other hand, when the “Not now” icon 515 shown in FIG. 7F is selected, the screen is switched to the channel screen shown in FIG. 7E.

Incidentally, if no content is reproduced/delivered yet, only the delivery start icon 517a is displayed as illustrated in FIG. 9C. Reproduction of the content including the image 506 of a participant is started over the entire screen as illustrated in FIG. 9C by drag-and-drop of the participant icon. On the other hand, if a participant icon has been dropped or content is being reproduced in the screen, the delivery start icon 517a and the delivery start icon 517b are displayed as illustrated in FIG. 9C. In this case, by drag-and-drop of a participant icon onto the delivery start icon 517b, content is displayed in an additional small window as a split window as illustrated in the right side of FIG. 9C. On the other hand, if drag-and-drop of a participant icon is performed onto the delivery start icon 517a, content is displayed over the entire screen to replace the content which is currently reproduced as illustrated in FIG. 9C.

In the case where a participant has already participated in a group and the participant desires to leave this group, the participant icon 512a is dragged from the channel screen 510 to the outside of the screen as a drag-and-drop operation as illustrated in FIG. 9D. When this operation is performed, the live participant terminal 1 of the participant is logged out from the group of the group talk, and thereafter the participant icon 512a is deleted from the channel screen 510.

Next is an explanation of the display form for the live participant terminal 1b and the viewer terminal 3b such as a smartphone having a small size screen. When a group is created with the live participant terminal 1b, a home screen 520 is displayed as illustrated in FIG. 8A, and the user becomes the manager of the screen. This home screen 520 includes “user name+channel” in the upper left corner of the screen in the same manner as described above. Also, the home screen 520 includes a chatting icon 521 displayed in the upper right corner, a delivery start icon 524 displayed in the lower center, and a video mode icon 525 displayed in the lower right of the screen.

When the chatting icon 521 is tapped, a chatting screen 522 is displayed as illustrated in FIG. 8B. This chatting screen consists of a text input box 522a and a screen 522b in which is displayed text data which is input by other users. Also, when the delivery start icon 524 is tapped, delivery is started. In the case of the present embodiment, the live participant terminal 1b is set in an audio mode in which only sound is to be input by default so that, when the delivery start icon 524 is tapped, only voice of the user is acquired and transmitted to the communication network 5. On the other hand, when video mode icon 525 is tapped, the camera 115 of the live participant terminal 1b is activated to start taking a picture of the owner of the live participant terminal 1b. The positions of cameras differ among the terminals and thereby are not limited. If a camera is located in the screen side, the camera in the screen side is activated. The video data, which is captured, is displayed in the entirety of the screen, and the interfaces such as the chatting screen is superimposed over the photographed image.

Also, when a finger is put on a lower left position 523 of the home screen and slid therefrom outward in the left direction as a swipe operation as illustrated in FIG. 8A, a channel list screen 526 is displayed as illustrated in FIG. 8C. When tapping any entry of the list, the screen is switched to the channel screen opened by another user. Accordingly, also in this case, the users x, y and z can be a manager or a participant in accordance with the group. Incidentally, this other channel screen has the similar display form as shown in FIG. 8A.

On the other hand, when the viewer terminal 3b accesses the management server 2 and selects a predetermined channel, the channel screen of the manager is displayed as illustrated in FIG. 8E. In this case, the channel name and the chatting screen are displayed also in the viewer terminal 3b in the same manner as described above. In this case, if this channel is a channel in which a viewer can participate, as illustrated in FIG. 8E, a screen 528 is displayed to confirm whether to participate in this channel. The screen 528 includes a “Join” icon 528a to decide participation and a “Not now” icon 528b to decide nonparticipation.

When the “Join” icon 528a is selected, the viewer terminal 3b participates in the group. Conversely, when the “Not now” icon 528b is selected, the screen is switched to the top page of the channel screen rather than participating the group. Incidentally, although not shown in the figure, also in the case of this viewer terminal 3b, participant icons 512 are displayed in the lower center of the channel screen as illustrated in FIG. 7E, and the face of the participant imaged by the camera of the terminal, graphics set during member registration or the like may be displayed in the participant icon 512a to which a participant is assigned.

(Live Broadcasting Method)

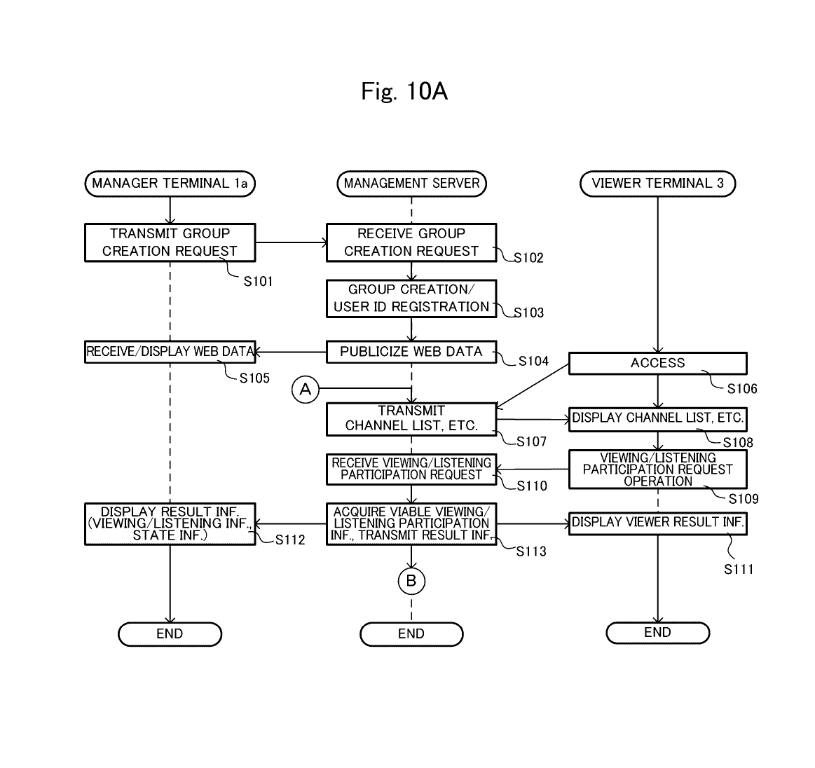

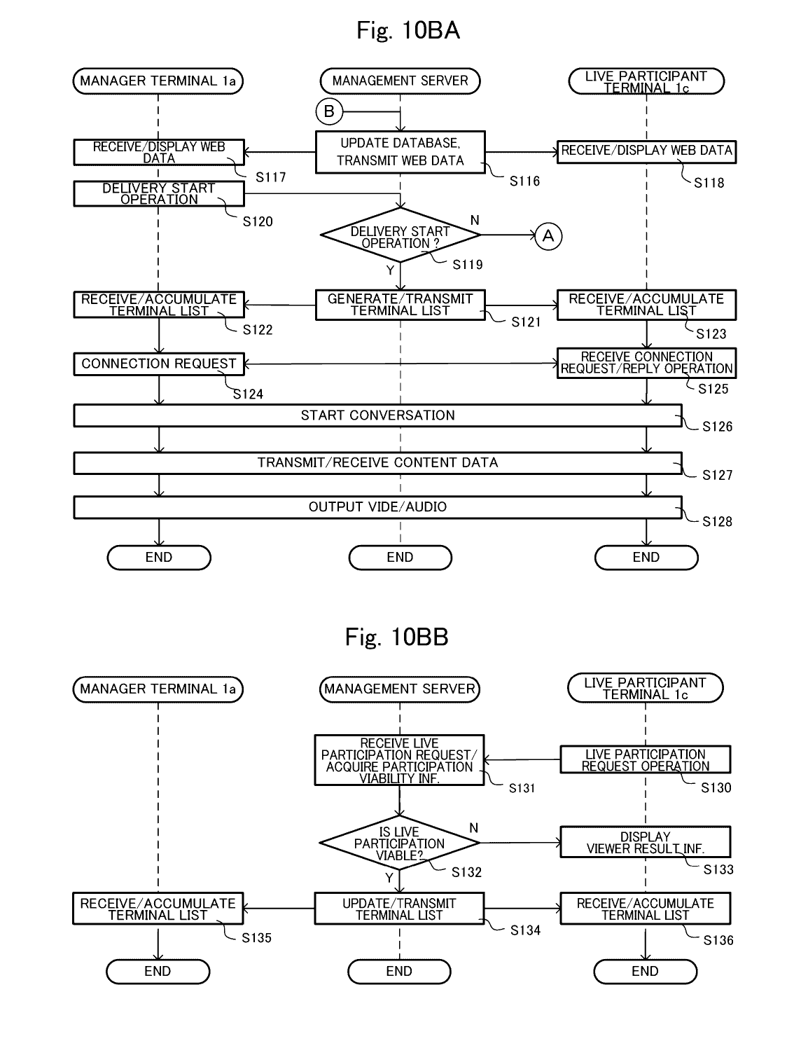

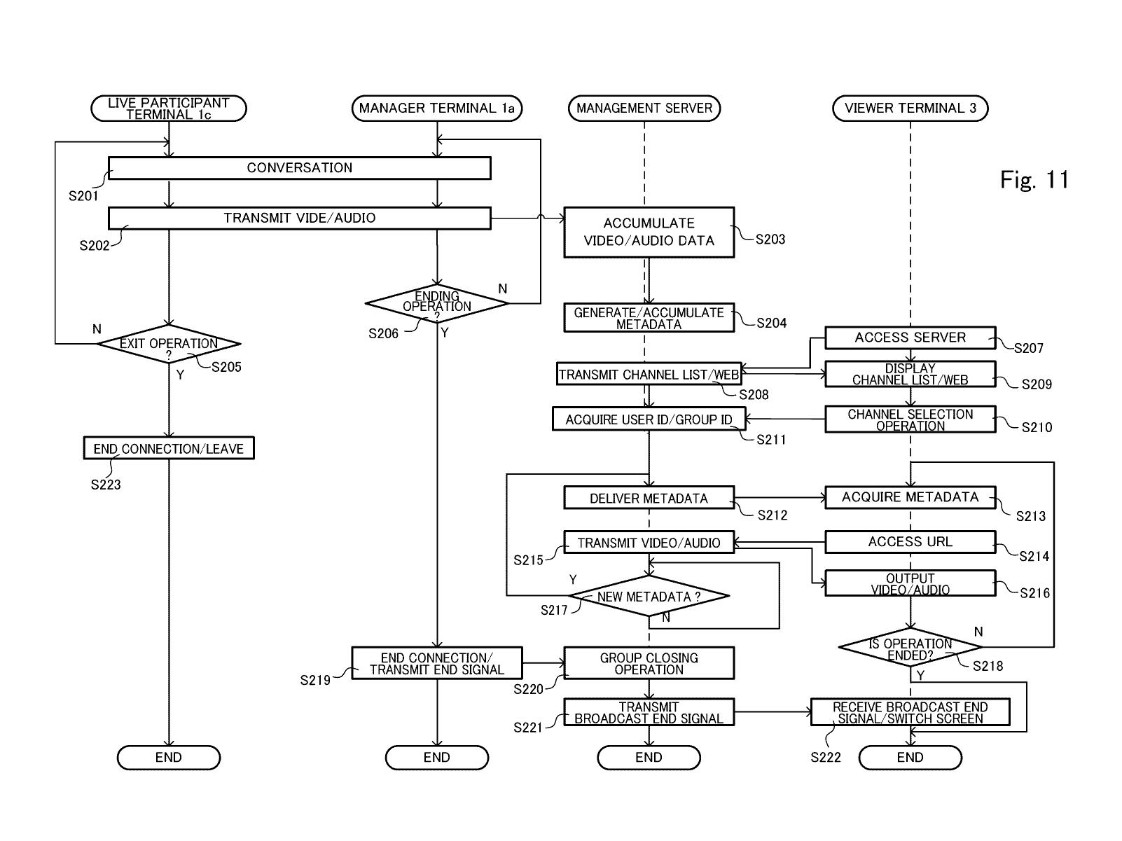

The live broadcasting method can be performed by operating the live broadcast system having the structure as described above. FIGS. 10A and 10B are sequence flow charts showing the operations from creating a talk group to starting conversation in accordance with the present embodiment. FIG. 11 is a sequence flow chart showing the operation of a viewer who views/listens conversation of a talk group in accordance with the first embodiment. Meanwhile, this example will be explained in the case where the user x operates the manager terminal 1a to create a group (channel), and another user y participates in the group. Incidentally, in the following explanation, before participating the group, the user y is a viewer so that the terminal used by the user y is referred to as the viewer terminal 3 and, after participating the group, the user y is a live participant so that the terminal used by the user y is referred to as the live participant terminal 1c. Furthermore, in this case, it is assumed that member registration of the live participant terminal 1 and the viewer terminal 3 has been completed in the management server 2.

First, the manager terminal 1a accesses the management server 2, and an authentication screen is displayed in a Web page. A user ID, a password and the like are then input through the manager terminal 1a, and the authentication unit 221 of the management server 2 performs an authentication process on the basis of the user ID, the password and the like which are input. If the authentication fails, error indication is displayed on the screen of the manager terminal 1a followed by prompting to input authentication information such as a user ID, a password and the like again.

Conversely, if the authentication succeeds, a Web page providing channels which can be viewed/listened or participated is transmitted to the manager terminal 1a. In this example, it is assumed that the user x performs a group creation operation for creating a new channel (S101). After performing the group creation operation, a group creation signal is transmitted to the group creation unit 222a of the management server 2.

Receiving the group creation signal (S102), the group creation unit 222a adds a group ID to the created group, registers anew the group in the group database 232, and registers, in a group manager list, the user ID acquired from the manager terminal 1a which requests group creation (S103). Also, the group creation unit 222a sets a participation limited number in the group database 232 on the basis of input information from the live participant terminal 1.

The data transmitting unit 223 makes public the group registered anew in this group database 232 on a Web site as a new channel (S104). Receiving the Web page of the created channel, the manager terminal 1a has the GUI control unit 103b generate an icon or the like linking to video data and audio data transmitted and received during a bidirectional call, and has the broadcast screen generation unit 103a display the generated icon on a broadcast screen in order that the icons can be selected by an operation signal of a live participant, generate a broadcast screen for outputting video and audio corresponding to each icon in response to a selection operation by the operation signal, and display the generated broadcast screen in the window 500 of the display unit 105. In this case, the home screen 501 and the channel list screen 508 are displayed on the display unit 105 of the manager terminal 1a as illustrated in FIG. 7A (S105).

Thereafter, when the user y accesses the management server 2 with the viewer terminal 3 (S106), an authentication process is performed in the same manner as described above. Incidentally, with respect to the authentication process of a viewer terminal, it is preferred that the user is permitted to view/listen without enforcing the authentication process by using an automatically assigned character string or the like as a user ID. If the authentication fails, error indication is displayed on the screen of the live participant terminal 1c followed by prompting to input authentication information such as a user ID, a password and the like again. Conversely, if the authentication succeeds, the data transmitting unit 223 transmits a channel list screen, the home page of each channel and the like to the live participant terminal 1b (S107). The viewer terminal 3 has the browser unit 32 display the channel list screen as shown in FIG. 7D and the home page of each channel as shown in FIG. 7E on the display unit 34 (S108).

Thereafter, the user y views/listens respective channels, decides a channel to be participated in, and performs a viewing/listening participation operation such as tapping the “Join” icon 514 of the Web page as illustrated in FIG. 7F (S109). When tapping the “Join” icon 514, a viewing/listening participation request signal is generated and received by the connection managing unit 222b of the management server 2 (S110).

The connection managing unit 222b transmits the participation request signal to the manager terminal 1a. Receiving this participation request signal, the manager terminal 1a automatically returns a permission response through an application to accept video and audio inputs from the participant. In this case, since the application automatically returns a permission response, participation is possible without operation by the manager after the “Join” icon 514 is tapped, i.e., after participation request. However, when returning a permission response, a camera permission dialog and designation of display position thereof may be requested. Incidentally, when such an automatic permission response is employed as described above, it is desirable to implement success limiting functionality such as filtering with a white list, limiting the number of participants and the like.

Also, when acquiring a viewing/listening participation viability information (S113) from the manager terminal 1a or as an automatic response, the connection managing unit 222b permits the viewer terminal 3 to connect with the P2P network 5a, transmits the result information of the viability to the manager terminal 1a, and transmits the result information to the viewer terminal 3 as viewer result information (S113). The manager terminal 1a then acquires this result information, and displays the acquired information as a viewing/listening information and a state information (S112). On the other hand, the viewer terminal 3 acquires this result information, and displays the acquired information on the display unit 34 (S111). Also, on the basis of the acquired permission signal, the connection managing unit 222b refers to the group database 232, and registers the user ID of the viewer terminal 3 in the participant list of the database to have the viewer terminal 3 participate a bidirectional call as the live participant terminal 1. Incidentally, the terminal used by the user y is changed thereby from the viewer terminal 3 to the live participant terminal 1c.

Thereafter, as illustrated in FIG. 10BA, the connection managing unit 222b delivers the data of the group database 232 to the terminals respectively after updating terminal registration (S116). This updated Web data is displayed on the manager terminal 1a of the user x who is the manager and the live participant terminal 1c of the user y who is a participant respectively (S117 and S118). Specifically, as illustrated in FIG. 9B, the participant icons 512 are displayed. While no delivery start signal is transmitted from the manager terminal 1a (i.e., the “N” branch from step S119), the process is returned to step A in the management server 2. When another live participant terminal 1 transmits a participation request, the process from step S106 to step S118 is repeatedly performed.

When the delivery start icon 503 is tapped (S120) by operation of the user x as illustrated in FIG. 7A, a delivery start signal is transmitted to the management server 2. Receiving this delivery start signal (the “Y” branch from step S119), the terminal list generation unit 222c of the management server 2 refers to the group database 232 on the basis of the group ID, extracts the users ID registered in the group manager list and the participant list, and extracts the IP addresses associated with the users ID from the user database 231 to generate a terminal list (S121). The generated terminal list is then transmitted to the manager terminal 1a and the live participant terminal 1c, and these terminals receive the terminal list (S122 and S123).

Receiving the terminal list, the manager terminal 1a has the connection request unit 102a select another live participant terminal 1c in the group on the basis of the IP addresses of the terminal list, followed by transmitting a connection request (S124). The live participant terminal 1c receives the connection request and automatically returns a reply signal by an application (S125) so that the manager terminal 1a and the live participant terminal 1c are connected with each other to start conversation (S126). Incidentally, while the automatic response to the connection request makes it possible to simplify operation and facilitate live viewing/listening in the group, it is preferred, when such automatic response is employed, to provide the functionality for exclusion except acceptable users (white list) and supporting a private mode of the entire group.

When starting conversation, the terminals 1a and 1 c transmit and receive video and audio acquired with the camera 115 and the microphone 114 which are input devices on a real time base through the P2P network 5a to perform a bidirectional call. Specifically, the camera 115 is activated to take video data of the owner followed by transmitting the video data to the communication partner, and the voice signal input through the microphone 114 is converted to IP packetized audio data through the voice conversation unit 112 and the VoIP unit 110. The content delivery unit 102d transmits the video data and the audio data to the communication partner respectively (S127).

The terminals 1a and 1 c receive content data acquired from the communication partner through the content receiving unit 102b. The content restructuring unit 102c restructures part or all of content data transmitted from another live participant terminal 1, and the restructured content data is transmitted to the cash unit 107a.

In advance of performing content reproduction by the broadcast screen generation unit 103a, the acquired content data is downloaded and stored in the cash unit 107a, the broadcast screen generation unit 103a displays the broadcast screen on the display unit 105 in order to embed, in the broadcast screen, the reproduction screen of a Web page which is provided by parsing the content data with the broadcast screen generation unit 103, and the audio data is output through the speaker 113 as sound (S128).

Incidentally, while delivery is started by the group including the user x and the user y in the case of the present embodiment, participation of another live participant terminal 1 is accepted if there is a vacancy in the number of participants even before or after starting delivery. When another live participant terminal 1 participates in the group, the process from step S106 to step S118 is performed. Also, the manager terminal 1a can output video and audio relating to each icon in response to an operation signal input to the manager terminal 1a by controlling a bidirectional call and delivery through the P2P network 5a and the communication network 5 as described above.

Specifically describing here the operation when participating a live, as illustrated in FIG. 10BB, the user desiring participation decides a channel which is desired to participate in, and performs a live participation request operation (S130). For example, as has been discussed above, a live participation request signal is generated, for example, by tapping the “Join” icon 514, and received by the connection managing unit 222b of the management server 2 (S131).

In this step S131, the connection managing unit 222b transmits the live participation request signal to the manager terminal 1a. Receiving this live participation request signal, the manager terminal 1a automatically returns a permission response through an application to accept video and audio inputs from the participant. In this case, since the application automatically returns a permission response, participation is viable without operation by the manager after the “Join” icon 514 is tapped, i.e., after participation request. However, when returning a permission response, a camera permission dialog and designation of display position thereof may be requested. Incidentally, when such an automatic permission response is employed as described above, it is desirable to implement success limiting functionality such as filtering with a white list, limiting the number of participants and the like.

Next, when acquiring a viewing/listening participation viability information from the manager terminal 1a or as an automatic response, the connection managing unit 222b determines if live participation is viable in accordance with the information (S132). Then, if live participation is not viable (i.e., the “N” branch from step S132), this fact is displayed in the live participant terminal 1c side as viewer result information (S133). Conversely, if live participation is viable (i.e., the “Y” branch from step S132), the connection managing unit 222b permits the viewer terminal 3 to connect with the P2P network 5a, transmits the result information of the viability to the manager terminal 1a, and transmits the result information to the viewer terminal 3 as a viewer result information. The manager terminal 1a then acquires this result information, and displays the acquired information as a viewing/listening information and a state information. On the other hand, the viewer terminal 3 acquires this result information, and displays the acquired information on the display unit 34.

Thereafter, on the basis of the acquired permission signal, the connection managing unit 222b refers to the group database 232, and updates the terminal list by registering the user ID of the viewer terminal 3 in the participant list of the database and the like, followed by transmitting the updated terminal list to the manager terminal 1a and the live participant terminal 1c (S134). The updated terminal list is accumulated in the manager terminal 1a and the live participant terminal 1c by receiving this terminal list (S135, S136).

Next is an explanation of operation when a viewer views/listens the conversation of a talk group. First, as illustrated in FIG. 11, when the manager terminal 1a and the live participant terminal 1c is performing conversation (S201), the content delivery units 102d of the manager terminal 1a and live participant terminal 1c transmit audio data and video data to the management server 2 respectively together with the group ID and the user IDs added to the audio data and video data (S202). The management server 2 acquires content data from each terminal, and accumulates the content data in the content information accumulating unit 234 on the basis of the group ID in association with the user ID (S203). After the content data is received in the content information accumulating unit 234, the metadata generation unit 224 generates metadata relating to the acquired content data which is then accumulated in the content information accumulating unit 234 (S204). Incidentally, this metadata contains information about the group (attributes of the channel, explanation text and the like) about the group, reproduction times and the path (IP address information) to the content information accumulating unit 234.

While the manager terminal 1a does not perform an operation of ending delivery (i.e., the “N” branch from step S205) or the live participant terminal 1c does not perform an exit operation (i.e., the “N” branch from step S206), the process from step S201 to step S204 is repeatedly performed to accumulate the audio data and video data of the manager terminal 1a and live participant terminal 1c in the management server 2.

Thereafter, when the viewer terminal 3 accesses the management server 2 (S207) and performs an operation to view/listen a channel, the management server 2 transmits Web data of channel list information (S208). Meanwhile, in this case, user authentication may or may not be performed. The channel list as shown in FIG. 7D is displayed on the screen of the viewer terminal 3 (S209), and when user operation is performed to select a certain channel, a viewing/listening request signal is transmitted to the management server 2 (S210). Receiving this viewing/listening request signal (S211), the management server 2 refers to the content information accumulating unit 234 and delivers the metadata of the group ID to the viewer terminal 3 on the basis of the group ID of the selected group (S212).

Receiving this metadata (S213), the viewer terminal 3 analyzes the metadata with the metadata analysis unit 32b, and accesses the management server 2 on the basis of acquired the address information (S214). The content distributing unit 223a of the management server 2 transmit the corresponding content data to the viewer terminal 3 in response to the access of the viewer terminal 3 (S215). Receiving the content data, the viewer terminal 3 displays the broadcast screen on the display unit 34 in order to embed the reproduction screen in a Web page which is reproduced by the content reproduction unit 32a, and the audio data is output through the speaker 38 as sound (S216).

The management server 2 regularly determines whether or not new metadata is generated (S217), and if it is determined that new metadata is accumulated (i.e., the “Y” branch from step S217) the management server 2 delivers the metadata to the viewer terminal 3 viewing/listening the group (S212). On the other hand, while a viewer does not perform an operation of ending viewing/listening (i.e., the “N” branch from step S218), the viewer terminal 3 continuously acquires metadata and accesses the management server 2 to acquire content data, and therefore the process from step S212 to step S218 is repeatedly performed. When the operation of ending viewing/listening is performed on the viewer terminal 3 (i.e., the “Y” branch from step S218), the connection between the viewer terminal 3 and the management server 2 is released and terminated.

If the user y as a participant performs an exit operation, the connection between the live participant terminal 1b and the manager terminal 1a is released, and the live participant terminal 1b leaves the group (S223). Furthermore, if the user x as a manager performs an operation of ending delivery (i.e., the “Y” branch from step S206), the connection with the live participant terminal 1b is released, and a connection end signal is transmitted to the management server 2 (S219). The management server 2 performs an operation of closing the group on the basis of the group ID (S220). Thereafter, the management server 2 transmits a broadcast end signal (S221), and the viewer terminal 3 receives the broadcast end signal and terminates the broadcast, for example, by switching the channel screen to a channel list screen (S222).

(Program)

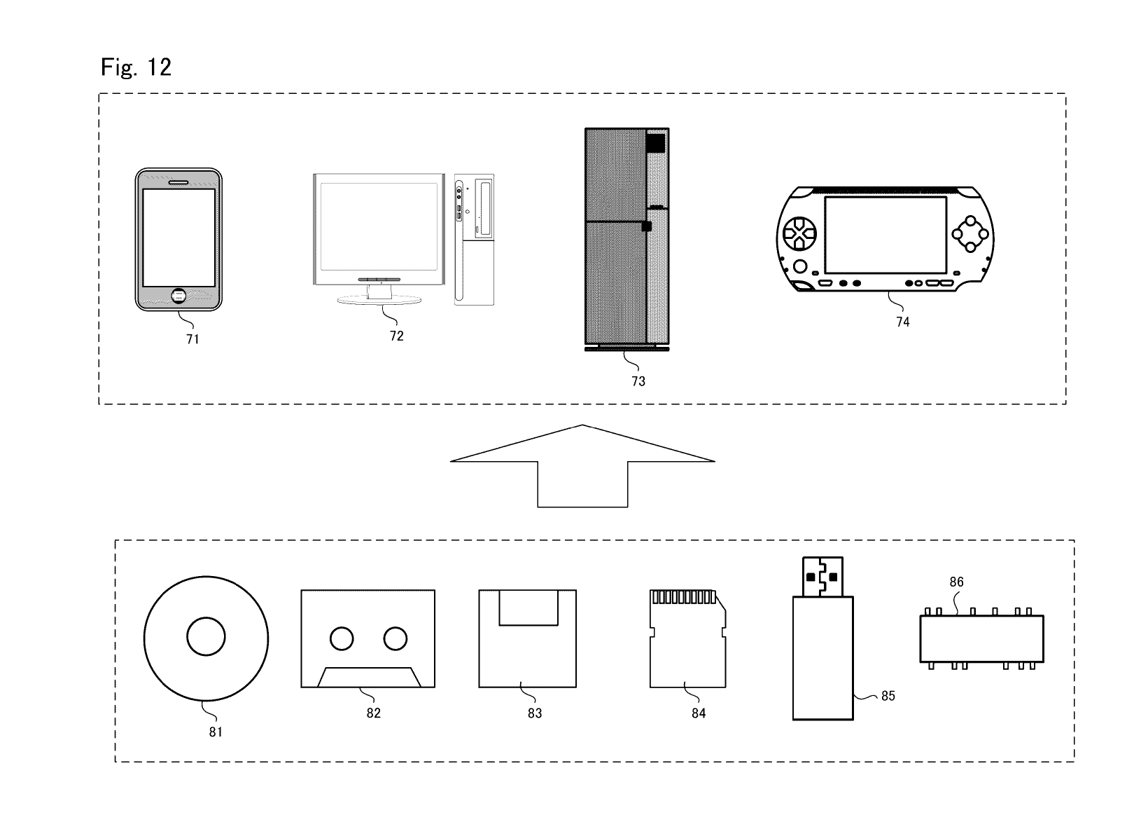

The live participant terminal 1, the viewer terminal 3 and the live broadcast method in accordance with the present embodiment as described above can be implemented by running a program written in an appropriate language on computers 71 to 74. Namely, as illustrated in FIG. 12, the live broadcast system having the functions as described above can easily be implemented by installing this program in a personal digital assistant (PDA), a mobile terminal apparatus 71 in which a cellular phone capability and a communication capability are integrally implemented, a personal computer 72 used on the client side, a server unit 73 located on a network and serving to provide data and functions on the client side, a dedicated apparatus 74 such as a game apparatus, or an IC chip 86, and running this program on a CPU. This program can be distributed, for example, through a communication line, or as a package application which can be run on a stand-alone computer.

In addition, such a program can be stored in computer readable mediums 81 to 85. Specifically, as illustrated in FIG. 12, the program can be stored in a variety of storage medium, e.g., a magnetic recording medium such as a flexible disk 83 or a cassette tape 82, an optical disc 81 such as CD-ROM or DVD-ROM, a USB memory 85, or a memory card 84.

(Effect/Action)

In accordance with the present embodiment as described above, the live participant communication unit 102 performs a bidirectional call by transmitting and receiving video and audio data acquired with the camera 115 and the microphone 114 on a real time base through the P2P network 5a formed by the live participant terminals 1, and thereby a viewer can view/listen the broadcast screen including video and audio of a talk among the live participant terminals 1 by generating the broadcast screen 530 in which is output video and audio transmitted and received during a bidirectional call, and transmitting and outputting the broadcast screen through the usual communication network 5 to the viewer terminal 3 used by each viewer.

Particularly, in the case of the present invention, since the broadcast screen generation unit displays icons designating video and audio transmitted and received during a bidirectional call in order that the icons can be selected by an operation signal of a live participant, and outputs video and audio corresponding to each icon in response to a selection operation by the operation signal, it is possible to perform a pleasant talk by viewing the broadcast screen and the partner's face at the same time while displaying presentation, video and audio attracting attention over the entire screen, to switch the broadcast by a gesture operation on an icon, and therefore to lessen the burden that the broadcast screen is operated by the user himself. Specifically, in the case of the present embodiment, since each icon is draggable so that the so-called “gesture operation” can be used to perform management operations as illustrated in FIGS. 9A to 9D, it is possible to minimize the number of buttons which are displayed on the screen at the same time, reflect a moving distance and the like on a real time base and enjoy the reality and intuition of the partner.

Also, in the case of the present embodiment, since the manager terminal 1a is further provided to control a bidirectional call and delivery through the P2P network 5a and the usual communication network 5, and the broadcast screen generation unit 103a is provided with the manager operation unit 103c which controls the output of video and audio corresponding to each icon 531 in response to the operation signal from the manager terminal 1a, for example, a group talk can smoothly be progressed by applying a right to speak to a predetermined live participant and prohibiting the other live participants from speaking during that time to prevent a plurality of live participants from speaking at the same time.

Furthermore, in the case of the present embodiment, since the connection managing unit 222b is further provided to permit a viewer terminal to connect with the P2P network 5a on the basis of a permission signal which is acquired from a live participant terminal 1, and the live participant communication unit 102 has the viewer terminal 3 permitted by the connection managing unit participate in a bidirectional call as a live participant terminal 1, it is possible to encourage a viewer viewing/listening a live broadcast to actively participate the live broadcast, and therefore attract interests in the live broadcast to increase the number of participants in the service of this system.

### Second Embodiment

Next is an explanation of a second embodiment of the present invention. The explanation of the present embodiment is directed to the example of delivering content data from the viewer terminal 3 which is an upstream node having the content data to a downstream node in the same group by the so-called overlay multicast method.

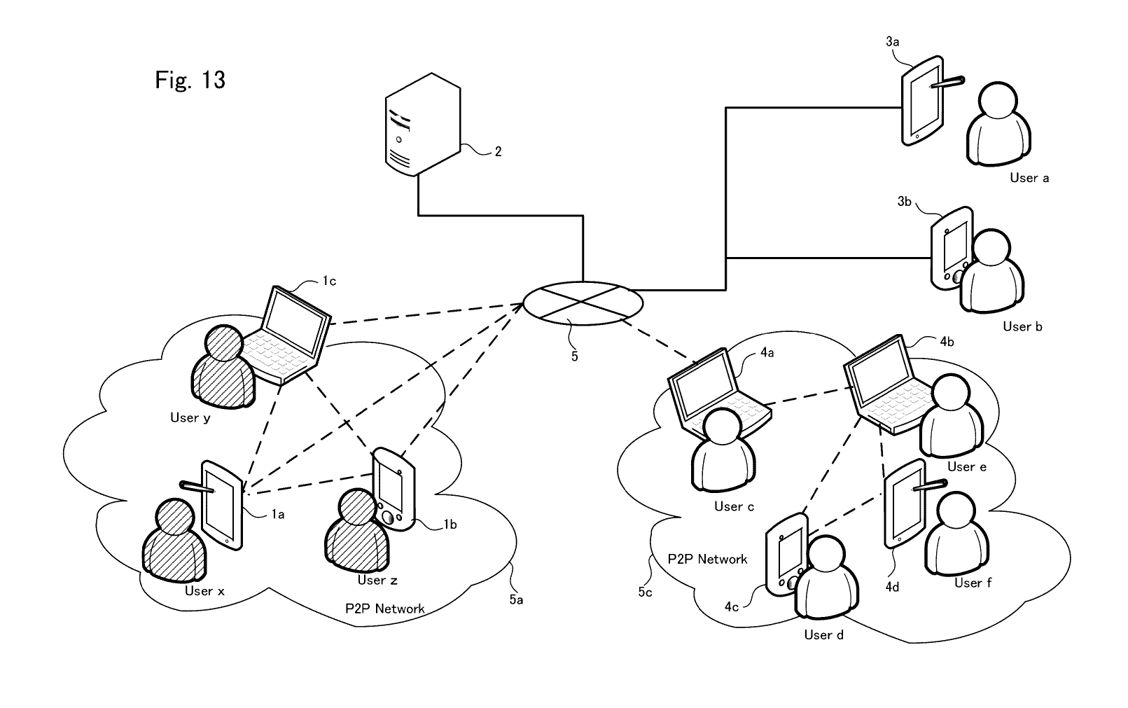

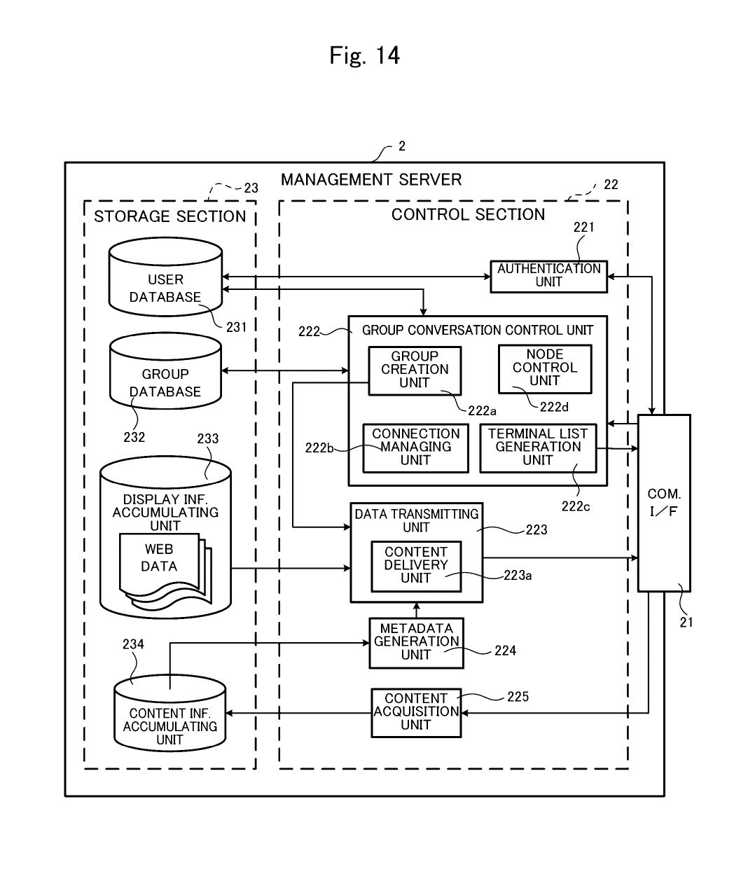

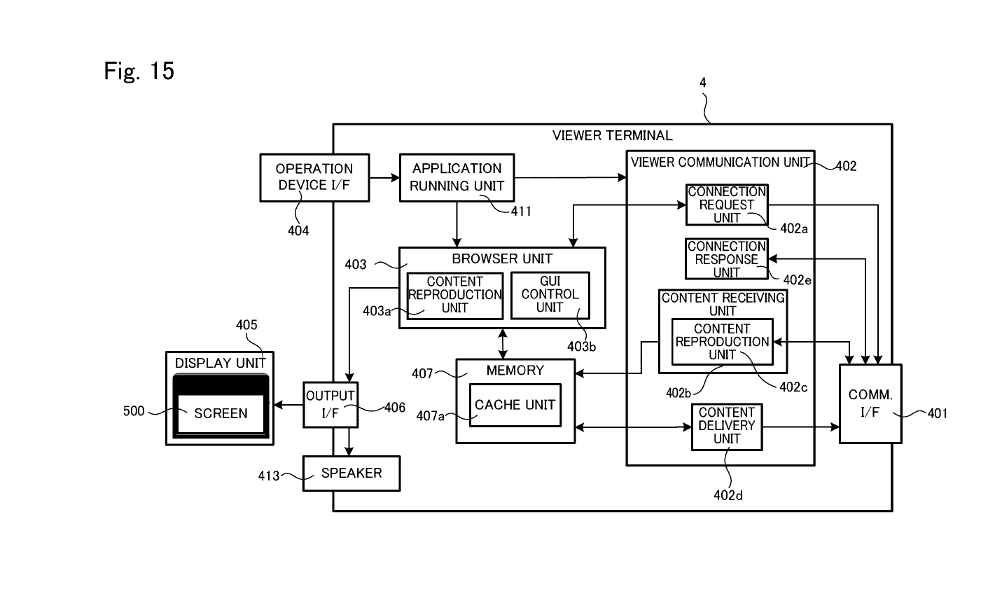

FIG. 13 is a block diagram for schematically showing the configuration of the live broadcast system in accordance with the second embodiment, FIG. 14 is a block diagram for showing the internal configuration of the management server in accordance with the second embodiment, and FIG. 15 is a block diagram for showing the internal configuration of the viewer terminal in accordance with the second embodiment. Meanwhile, in the description of the present embodiment, like reference numbers indicate functionally similar elements as the above first embodiment unless otherwise specified, and therefore no redundant description is repeated.

In the case of the present embodiment, as illustrated in FIG. 13, viewer terminals 3 and 4 are connected with the communication network 5. The terminals 3 and 4 are used by users a to f who are viewing/listening the talk in a group formed by a plurality of live participant terminals 1. In this example, the viewer terminals 3a and 3b used by the users a and b are connected with the management server 2 through the communication network 5 to receive metadata and content data from the management server 2 in the same manner as in the first embodiment.

On the other hand, the viewer terminals 4a to 4d used by the users c to f are arranged on a tree type network 5c of the so-called OLM system in which the viewer terminal 4a is connected with the management server 2 and the live participant terminal 1 as an upstream node, the viewer terminal 4b is connected in the downstream side of the viewer terminal 4a, and the viewer terminals 4c and 4d is further connected in the downstream side of the viewer terminal 4b. Meanwhile, in what follows, the viewer terminals 4a to 4d are collectively referred to as the viewer terminal 4.

Then, in the case of the present embodiment, the management server 2 is provided with a node control unit 222d in the group conversation control unit 222 as illustrated in FIG. 14. The node control unit 222d is a module for determining an upstream node which delivers content data to viewer terminals 4 located in the downstream side in the tree type network 5c. In this case, receiving a request signal from the viewer terminal 4 for viewing/listening a predetermined group, the node control unit 222d refers to the group database 232 on the basis of the selected group ID, selects a terminal connected with few downstream terminal(s) from among the live participant terminals 1 participating the group, and transmits a participation request and an authentication key to that live participant terminal 1.

Receiving a connection viability signal indicative that connection is viable and an authentication key from the live participant terminal 1 or the downstream viewer terminal 4, the node control unit 222d delivers delivery source information including the IP address of the delivery source, which is either the live participant terminal 1 or the viewer terminal 4, to the viewer terminal 4 transmitting the viewing/listening request, and delivers delivery destination information including the IP address of the viewer terminal 4 transmitting the viewing/listening request to the delivery source, which is either the live participant terminal 1 or the viewer terminal 4.

Incidentally, which of a viewer terminal 4 in the tree type network 5c or another viewer terminal 3 is the terminal transmitting the viewing/listening request may be determined by receiving an input from the user during user registration or automatically determined by detecting the network environment when accessed.

Next, the internal configuration of the viewer terminal 4 will be explained. Meanwhile, in the case of the present embodiment, it is assumed that the functions of the viewer terminal 4 as described below are implemented also in the live participant terminal 1 in the form of similar function modules. Specifically, as illustrated in FIG. 15, the viewer terminal 4 is provided with a communication interface 401 as a communication interface module. The communication interface 401 is a module for transmitting and receiving data as packets through the communication network 5. A terminal list and a connection request signal are transmitted and received by communicating with the management server 2 through this communication interface 401. Also, a delivery request and content data are transmitted and received by communicating with the live participant terminal 1 and another viewer terminal 4 through this communication interface 401.

The viewer terminal 4 is provided further with the memory 407. The memory 407 is a ROM device which stores programs and data of an OS (Operating System) and various applications, including a node list transmitted from the management server 2 and the like. The node list is a list of the viewer terminals 4 which are located in the upstream side of that node and from which content data is delivered and the viewer terminals 4 which are located in the downstream side of that node and to which content data is delivered. This list contains IP addresses and terminal IDs identifying the viewer terminals 4 respectively. When acquiring connection destination information or connection source information as transmitted from the node control unit 222d, the IP addresses of terminals contained in the information are successively recorded in this node list. Incidentally, the node list is usually provided to include one upstream node and at most a limited number of downstream nodes such that the viewer terminal 4 does not connect with downstream nodes exceeding the limited number.

Also, this memory 407 is provided with a cache unit 407a. The cash unit 407a is a buffer device for temporarily accumulating part or all of content data transmitted from another viewer terminal 4 in accordance with the tree type network 5c of the so-called OLM system (peer-to-peer). In the case of the present embodiment, the content data acquired in response to a delivery request is downloaded and stored in the cash unit 407a in advance of performing content reproduction by a content generation unit 403a. The data stored in this cash unit 407a can be shared with other viewer terminals 4 in accordance with the tree type network system. When a delivery request is transmitted from another viewer terminal 4, the data is transmitted to this another viewer terminal 4.

Furthermore, the viewer terminal 4 is provided with, as modules for reproducing content, an application running unit 411, an operation device interface 404, a browser unit 403 and an output interface 406.

The application running unit 411 is a module for running a general OS, browser software, and applications such as a media viewing application, and usually implemented with a CPU and the like. Meanwhile, in the case of the present embodiment, for example, the browser unit 403 is virtually implemented in the CPU by running the browser software with this application running unit 411, and the content generation unit 403a is virtually implemented in the CPU by running the media viewing application with this application running unit 411.

The operation device interface 404 is a module connected with operation devices such as a mouse, a touch panel and the like for inputting and outputting operation signals thereof. A user can perform an operation for starting a group talk with the application running unit 411 and these operation devices, and receive relevant services such as searching for channels which the user want to view.

The browser unit 403 is implemented by running the browser software as a module for viewing/listening Web pages by downloading HTML (HyperText Markup Language) files, image files and the like, and parsing layouts to display/reproduce the Web pages. Incidentally, it is also possible for users to transmit data to the management server 2 through a form, and run application software written in JavaScript (registered trademark), Flash, Java (registered trademark) and so forth.

Then, the browser unit 403 is provided with a GUI control unit 403b and the content generation unit 403a. The GUI control unit 403b is a module for controlling a graphic user interface (GUI) which is arranged in a screen 500 of the display unit 405 to display a screen relating to a group talk and accept user operations. In the case of the present embodiment, operation with the objects displayed in the screen 500 of the display unit 405 is received by the operation device interface 404 through the GUI, followed by transmitting the operation signal to the modules. The operation of this GUI is performed to request and end the viewing/listening of a channel and switch the channel. The operation is acquired through the operation device interface 404.

The content generation unit 403a is software which outputs content data accumulated in the cash unit 407a. Specifically, the content generation unit 403a displays image data in the broadcast screen of the display unit 405 by a control signal from the application running unit 411 and the operation device interface 404 in order that the image data is embedded in the browser unit 403 as a reproduction screen, and outputs audio through the speaker 413.

The output interface 406 is a module for outputting video and audio output signals through the display unit 405 and the speaker 413 respectively. The display unit 405 is, for example, a display device such as a liquid crystal display to display images, letters and the like through a window 500 which is generated by an application such as browser software. The speaker 413 is an output device which outputs sounds corresponding to audio signals and audio files, and in the case of the present embodiment the speaker 413 receives audio data acquired from the other live participant terminals 4 and outputs voice of each user.

Furthermore, the viewer terminal 4 is provided with a viewer communication unit 402 as a module group relating to the transmission and reception of broadcast images including content data. The viewer communication unit 402 is a module for receiving video and audio data acquired through the tree type network 5c and the P2P network 5a formed by the live participant terminals 1. Specifically, the viewer communication unit 402 is provided with a connection request unit 402a, a connection response unit 402e, a content receiving unit 402b and a content delivery unit 402d.

The connection request unit 402a is a module for requesting the management server 2 for viewing/listening content in the group. In the case of the present embodiment, a viewing/listening request signal and the group ID of the viewing/listening request are transmitted to the management server 2 by tapping a participation icon 512 displayed in the screen. This viewing/listening request signal of the present embodiment is transmitted to the node control unit 222d.

Receiving a participation request and an authentication key from the live participant terminal 1 which is an upstream node or the viewer terminal 4, the connection response unit 402e determines whether or not there is a vacancy in the number of downstream nodes by referring to the node list in the memory 407, and if there is a vacancy in the connection number, the connection response unit 402e returns a connection viability signal and the authentication key to the management server 2. On the other hand, if there is no vacancy in the connection number, the participation request and the authentication key are transferred to the viewer terminal 4 corresponding to any downstream node recorded in the node list. The connection response unit 402e of the viewer terminal 4 receiving the participation request and the authentication key determines connectivity by referring to the node list thereof in the same manner as described above. This is repeated until the connection destination of the viewer terminal 4 issuing the viewing/listening request is determined.

The content delivery unit 402d is a module for delivering content data received from an upstream node to the viewer terminal 4 which is a downstream node. In the case of the present embodiment, part or all of content data is delivered to the viewer terminal 4 which is a downstream node on the basis of the node list.

The content receiving unit 402b is a module for receiving content data, which is received through the communication interface 401, in order to receive part or all of content data from the viewer terminal 4 or the live participant terminal 1, which is an upstream node, and store the data to a memory 407. In this case, the content receiving unit 402b is provided with a content restructuring unit 402c. The content restructuring unit 402c is a module for restructuring part or all of content data transmitted from the live participant terminal 1 or another viewer terminal 4 through the tree type network 5c and the P2P network 5a, and the restructured content data is transmitted to the cash unit 407a.

(Live Broadcast Method)

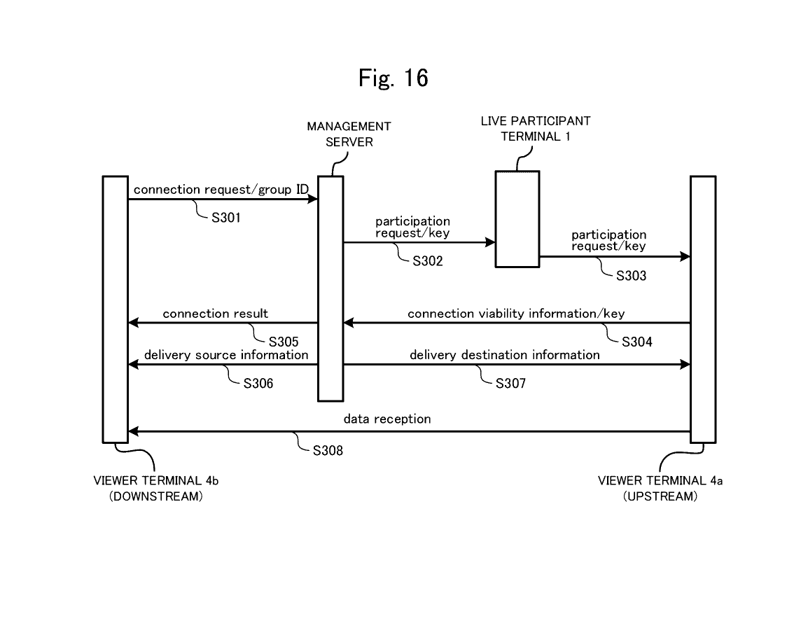

The live broadcast method can be implemented by operating the live broadcast system having the structure as described above. FIG. 16 is a sequence diagram for showing the content delivery process to the viewer terminal in accordance with the second embodiment. Meanwhile, this example will be explained in the case where the user e operates the viewer terminal 4b to view/listen the channel of the live participant terminal 1. It is assumed here that a predetermined group has been formed by a plurality of live participant terminals 1, and that the viewer terminal 4a located in the upstream side of the viewer terminal 4b is connected with the live participant terminal 1 and the management server 2.

First, when the viewer terminal 4b accesses the management server 2 and performs an operation to view/listen a channel, the management server 2 transmits Web data of channel list information in the same manner as in the first embodiment. The channel list is then displayed. Then, when user operation is performed to select a certain channel, a viewing/listening request signal and a group ID are transmitted to the management server 2 (S301).

When receiving a delivery request for a predetermined group from the viewer terminal 4b, the communication interface 401 of the management server 2 determines the network environment. Since the viewer terminal 4b is located on the OLM based network, the delivery request is transmitted to the node control unit 222d.

When receiving a delivery request for a predetermined group from the viewer terminal 4b, the node control unit 222d determines the network environment, refers to the group database 232 on the basis of the selected group ID, selects a terminal connected with few downstream terminal(s) from among the live participant terminals 1 participating the group, and transmits a participation request and an authentication key to that live participant terminal 1 (S302).

When receiving a participation request and an authentication key, the connection response unit 402e of the live participant terminal 1 determines whether or not there is a vacancy in the number of downstream nodes by referring to the node list in the memory 407. Meanwhile, in this case, it is assumed that there is no vacancy in the connection number of the live participant terminal 1. In this case, since there is no vacancy in the connection number, the connection response unit 402e of the live participant terminal 1 transfers the participation request and the authentication key to the viewer terminal 4a corresponding to a downstream node (S303).

The connection response unit 402e of the viewer terminal 4a receives the participation request and the authentication key, and determines whether or not there is a vacancy in the number of downstream nodes by referring to the node list in the memory 407. Meanwhile, it is assumed here that there is no vacancy in the connection number of the viewer terminal 4a. In this case, since there is a vacancy in the connection number, the connection response unit 402e of the viewer terminal 4a returns a connection viability signal and the authentication key to the management server 2 (S304).

When acquiring the connection viability signal and the authentication key, the node control unit 222d of the management server 2 performs authentication with the authentication key, and then determines the viewer terminal 4a as the connection destination of the viewer terminal 4b.

Thereafter, the node control unit 222d delivers the connection result to the viewer terminal 4 transmitting the viewing/listening request (S305), and delivers delivery source information including the IP address of the delivery source, which is either the live participant terminal 1 or the viewer terminal 4, to the viewer terminal 4 transmitting the viewing/listening request (S306). On the other hand, the node control unit 222d delivers delivery destination information including the IP address of the viewer terminal 4, which is the delivery destination, to the delivery source, which is either the live participant terminal 1 or the viewer terminal 4 (S307).

Thereafter, for example, the viewer terminal 4a and the viewer terminal 4b are connected with each other in response to the connection request from the viewer terminal 4b, which then delivers a broadcast screen including part or all of content data to the viewer terminal 4a (S308). When receive this content data, the viewer terminal 4b displays image data in the window of the display unit 405 in order that the broadcast screen is embedded in a Web page reproduced by the content generation unit 403a of the browser unit 403, and outputs audio through the speaker 413.

(Effect/Action)

In accordance with the second embodiment as described above, there are the same effects and actions as in the above first embodiment. Furthermore, in accordance with the second embodiment, since the upstream viewer terminal 3 distributes delivery of a broadcast screen by transmitting content data to a downstream node terminal of a group through the tree type network 5c of the so-called OLM system on the basis of a node list, even when the number of viewers viewing/listening the live broadcast system is increased, it is possible to prevent access concentration to the management server 2 and lessen communication load.

### Third Embodiment

Next is an explanation of a third embodiment of the present invention. The gist of the present embodiment resides in providing an additional function of reproducing and displaying content in a screen during broadcast as described in the above first and second embodiments. In this case, the content is provided in a variety of representation forms such as still images, motion images and sound, and includes external content accumulated in an external server, internal content accumulated in the live participant terminal 1 and so forth.

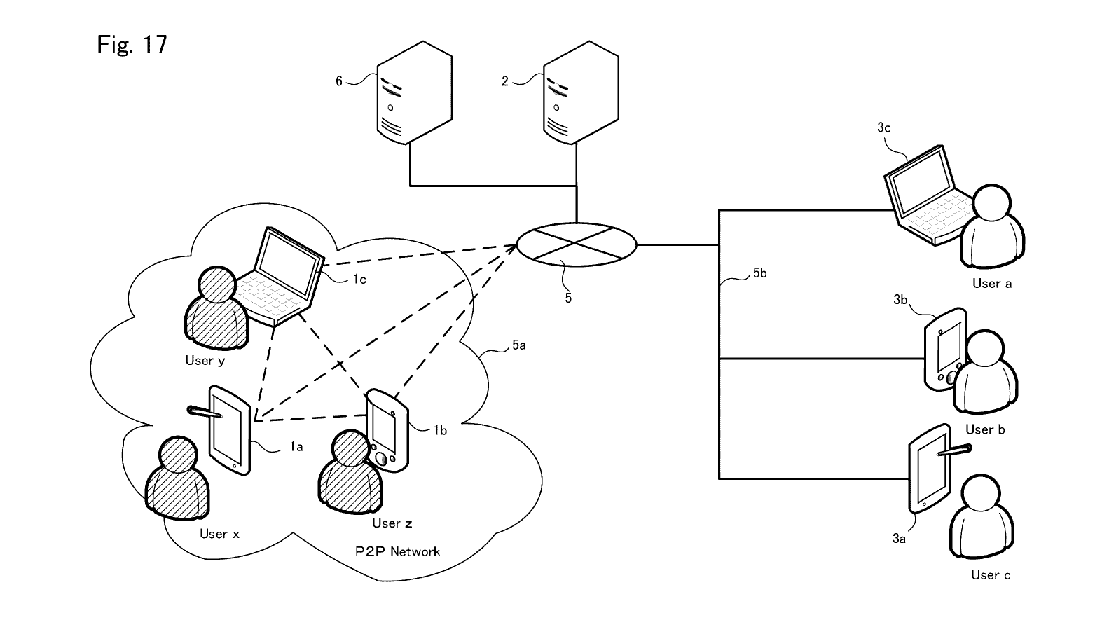

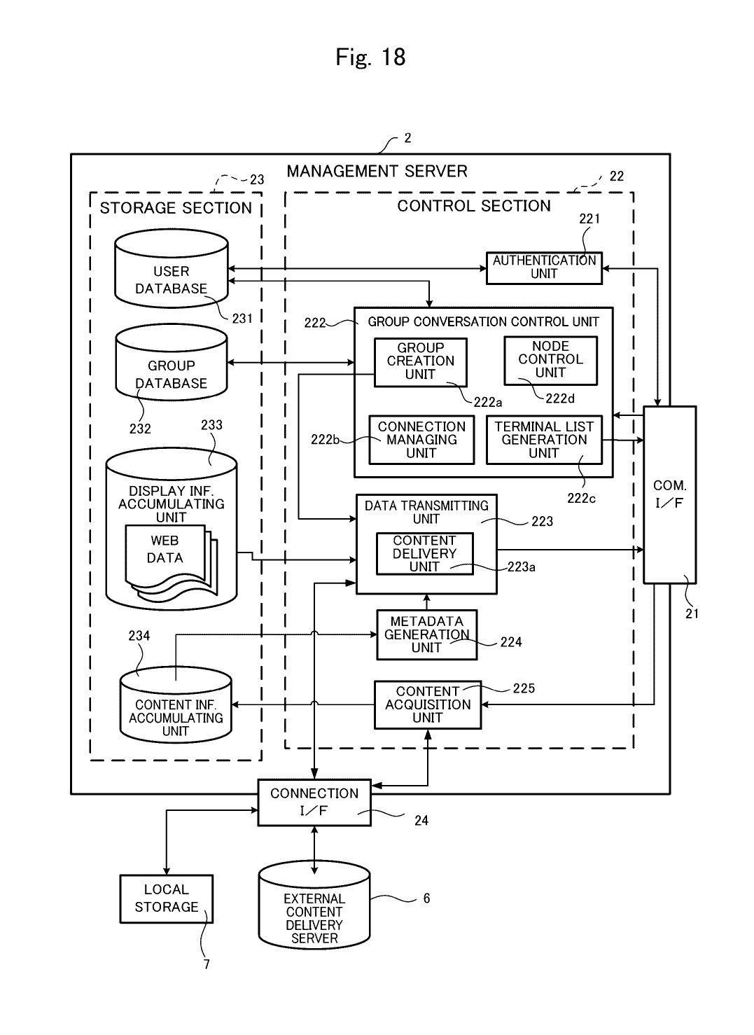

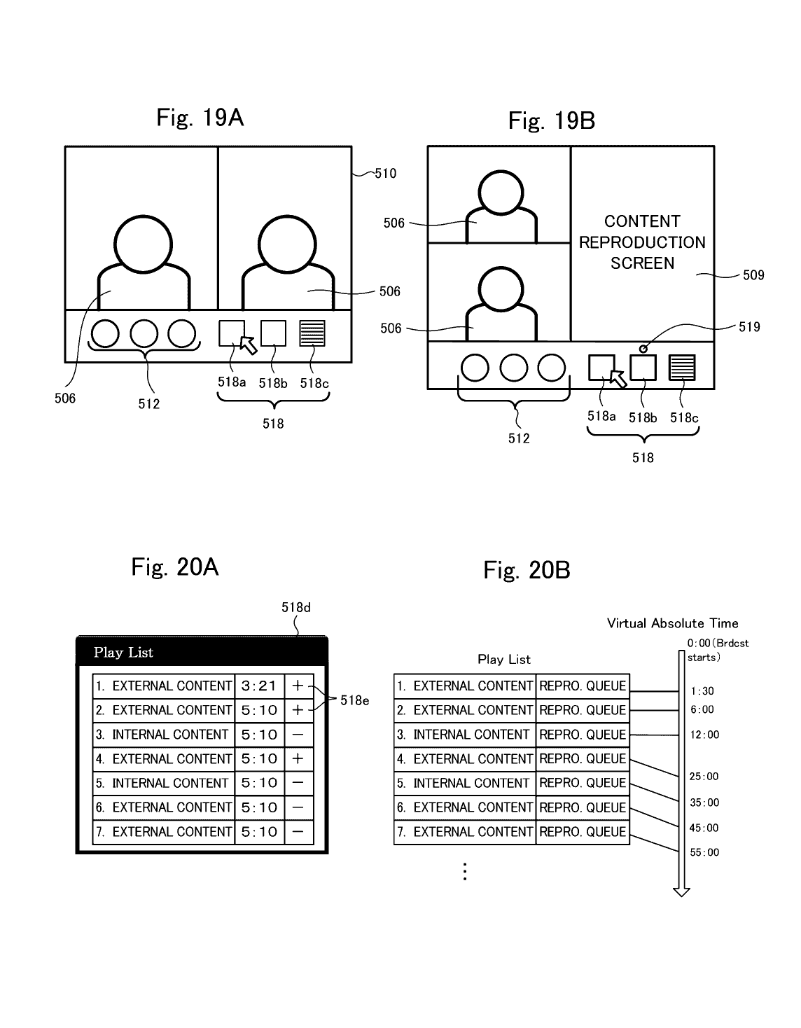

FIG. 17 is a schematic representation showing the overall configuration of the system in accordance with the third embodiment. FIG. 18 is a block diagram for showing the internal structure of the management server in accordance with the third embodiment. FIGS. 19A and 19B are explanatory views for showing display forms in the broadcast screen in accordance with the third embodiment. FIGS. 20A and 20B are explanatory views for showing a play list and a reproduction queue embedded in the play list in accordance with the third embodiment.

As shown in FIG. 17, the live broadcast system of the present embodiment includes the communication network 5 with which are connected an external content delivery server 6 which accumulates and delivers a plurality of content items, and a local storage 7.

This external content delivery server 6 is a server device which is managed and operated by a person other than the person who manages the present system, and implemented as a server computer or software having functionality for transmitting information such as HTML (HyperText Markup Language) files, image files, video files and music files in a document system such as WWW (World Wide Web) to accumulate information such as HTML documents and images and deliver these information items in response to a request of a client software such as a Web browser through an IP network such as the Internet. The management server 2 of the present embodiment acquires content from this external content delivery server 6 and reproduces the content in the screen of the live participant terminal 1. The local storage 7 is a storage device such as the memory 107 of the live participant terminal 1 which accumulates internal content possessed by each user.

The management server 2 is provided with a connection interface 24 as illustrated in FIG. 18, and connected with the external content delivery server 6 and the local storage 7 through the communication network 5. The connection interface 24 is a communication interface for transmitting and receiving data from/to the external content delivery server 6 through the communication network 5.

Also, in the case of the present embodiment, the content acquisition unit 225 is a module for acquiring external content from the external content delivery server 6 and internal content from the local storage 7. The content acquisition unit 225 of the present embodiment acquires URL information indicative of the location of external content accumulated in the external content delivery server 6 in response to a posting operation of the live participant terminal 1, and stores the URL information in the content information accumulating unit 234.

On the other hand, the content acquisition unit 225 acquires internal content from the local storage 7 in response to an upload (posting) operation of the live participant terminal, and stores the internal content in the content information accumulating unit 234. The URL information of the external content, which is posted, and the internal content are associated with user IDs, and stored in the content information accumulating unit 234 for each user ID. Incidentally, the content acquisition unit 225 may acquire content data from the external content delivery server 6 and stored in the content information accumulating unit 234.

Also, the content information accumulating unit 234 accumulates play lists and reproduction queues associated with user IDs respectively. In this case, the play list is a list in which are recorded all the items of the external content and the internal content together with the order of reproduction, and the reproduction queue is a list of content items in the play list which are set to be used and reproduced during broadcast. When external content, internal content and a reproduction queue describing the order of reproduction are set up by user operation, as illustrated in FIG. 19A, content reproduction icons 518 are displayed adjacent to participant icons 512. These content reproduction icons include an external content reproduction icon 518a, an internal content reproduction icon 518b and a play list icon 518c corresponding to link destinations of content selected by the user.

In the case of the present embodiment, the external content reproduction icon 518a and the internal content reproduction icon 518b are displayed when content is recently posted in the content information accumulating unit 234, and when predetermined content is selected from the play list. Specifically, the play list icon 518c is displayed in the initial screen so that a list of content items which are not displayed in the screen can be viewed. Then, if the user select the play list icon 518c, a window is pop-up displayed to display content items in a list as illustrated in FIG. 20A and, when selecting an add button 518e of any one item of the content row (“add to the reproduction queue” button, the icon corresponding to the content item is displayed in the screen as the external content reproduction icon 518a or the internal content reproduction icon 518b. Incidentally, as illustrated in the list of FIG. 20A, content which can be added is indicated by an add button 518e labelled “+”, and content which has already been selected and added is indicated by an add button 518e labelled “−”. Furthermore, the playback time of each content item is displayed in the window of the list.

On the other hand, even without user operation, new content which have been recently added to the content information accumulating unit 234 may be automatically displayed in the screen as the icons 518a and 518b. In this case, new content is displayed in the screen, for example, such that when four or more content items are added in the last hour all the content items are displayed, that when one or more content items are added in the last one day at most four content items are displayed, and that when one or more content items are added in the last two days at most two content items are displayed. Meanwhile, the relationship between the posting timing and the number of icons to be displayed in the screen is not limited to that as described above, but can be modified variously.

Furthermore, in the case of the present embodiment, for example, content recently posted by other users than the live participants can also be displayed as icons. The content recently posted by other users may be content posted to the live broadcast system or content posted to the external content delivery server 6. In this case, the content acquisition unit 225 stores external content and internal content posted by users in the content information accumulating unit 234 as common content, and the common content is displayed in accordance with the posting times and the limitation of number of items as described above. Meanwhile, when the icons 518a and 518b are automatically displayed, an icon 519 is displayed in the vicinity of the icon 518b to indicate a new arrival so that the user can distinguish the new content from content which is manually added by user operation as illustrated in FIG. 19B.

Then, if the user performs a selection operation of the icon 518 during broadcast, the content delivery unit 223a delivers the content corresponding to the icon 518 to the live participant terminal 1. Specifically, when the external content icon 518a is selected, the URL information of the external content is acquired from the content information accumulating unit 234 on the basis of the user ID, and the external content is acquired from the external content delivery server 6 on the basis of the URL information and delivered to the live participant terminal 1 in the group. On the other hand, when the internal content icon 518b is selected, the internal content is acquired from the content information accumulating unit on the basis of the user ID and delivered to the live participant terminal 1 in the group.

Furthermore, when the play list icon 518c is selected, the content items of the play list are automatically and sequentially selected in the description order. Internal content or external content is delivered from the management server 2 to the live participant terminal 1 in accordance with the type of the selected content so that the content receiving unit 102b of the live participant terminal 1 receives the content from the management server 2.

Thereafter, as illustrated in FIG. 19B, the broadcast screen generation unit 103a of the live participant terminal 1 reduces the areas for displaying videos 506 of imaged users, generating a content reproduction screen 509, and reproducing content by embedding the content in the content reproduction screen 509.

Also, the content displayed in the screen is given a group ID by the content acquisition unit 225, accumulated in the content information accumulating unit 234 as content having been broadcasted, and successively delivered to the viewer terminal 3.

Meanwhile, in the case of the present embodiment, the play list is a list in which are described a plurality of content items which are delivered in response to the selection operation by the live participant. However, as illustrated in FIG. 20B, the content items may be automatically reproduced without a user operation by automatically setting reproduction start times common to the live participants as an automatic reproduction function.

Specifically, the automatic reproduction function is implemented by utilizing time-based data which is virtually defined over the live participant terminals 1 and sharing absolute virtual time information progressing in synchronism with the broadcast process among the live participants. In the case of the present embodiment, the broadcast screen generation unit 103a of the live participant terminal 1 has a function to monitor the reproduction time of content to be reproduced in order to display the content in the screen in a particular time as a trigger which is described in a reproduction queue while broadcast is in progress. The content is thereby automatically reproduced in the screen as illustrated in FIG. 19B when a predetermined time elapses after broadcast starts.

Incidentally, the play list is not necessarily provided in order that all the content items are successively reproduced, but may be provided for example with an interruption function to start reproduction of a content item while the previous content item is being reproduced, and a skipping function to stop reproduction of a content item in the middle and start displaying the next content. Furthermore, in the case of the present embodiment, the broadcast screen generation unit 103a has a function to make time virtually proceed even if content is not displayed in the screen so that, for example, when a user performs a display operation, the content is reproduced from a position corresponding to the elapsed time from the start of broadcasting. By this configuration, for example, it is possible to make the time proceed with respect to the previous content item while the interrupting content item is being reproduced as described above, and start reproduction of the previous content item from the position corresponding to the elapsed time after reproduction of the interrupting content ends.

As has been discussed above, in the case of the present embodiment, since content is shared and display in the screen during a live broadcast, a talk can be performed while reviewing content related to the topics of the live broadcast as a reference. Particularly, in the case of the present embodiment, content is automatically displayed in accordance with the progress of broadcast by generating a play list of a plurality of content items and embedding a reproduction queue in which reproduction start times are set in advance, and therefore the users can have a talk with automatic reproduction of content to smoothly proceed with the broadcast.

### Modified Embodiments

Incidentally, the present invention is not limited to the above embodiments but can be modified in various ways. For example, the above embodiments are implemented to perform a live broadcast, i.e., on a real time base. However, for example, content prepared by recording a live broadcast can be used also as delivery content. In this case, automatic delivery can be performed in accordance with a reproduction queue by automatically preparing a list of video and audio which are recently uploaded.

For example, live videos which are recorded are compiled in a list in accordance with categories and ranking, and linked to virtual channels so that the linked videos in the list can be viewed/listened by selecting a channel. The content items in the list of each channel are loop reproduced, and a user can acquire a reproduction queue by selecting the channel, and view/listen the channel by receiving the position of a medium to be reproduced at that time in accordance with the acquired reproduction queue to reproduce the content.

In this case, the viewer can cache/preload content from a medium for each channel in advance or in parallel with a reproduction process, and therefore data download can be prevented from being redundantly performed to realize pleasant viewing/listening in a mobile environment, in which a bandwidth is limited. Furthermore, a viewer client can perform zapping of channels, which may be even recorded channels, in the same manner as radio programs or TV programs, to encourage long viewing/listening while performing something without a selection operation of a medium.

Incidentally, the recorded content (recorded medium data) as described above can easily be uploaded for example from an existing video sharing service or a mobile terminal such as a smartphone to lessen/simplify operations/manipulation burdens in the delivery side peculiar to realtime delivery, and a viewer can freely view/listen content meeting needs to collect users. For example, when performing live broadcast of finally important content on a real time base, it is possible to acquire much viewers in advance of the broadcast and improve customer gathering power.

### DESCRIPTION OF REFERENCE SIGNS

1(1a to 1c) . . . live participant terminal
1a . . . manager terminal
2 . . . management server
3(3a to 3c), 4(4a to 4d) . . . viewer terminal
5 . . . communication network
5a . . . P2P network
6 . . . external content delivery server
7 . . . local storage
21 . . . communication interface
22 . . . control unit
23 . . . storing unit
24 . . . connection interface
31 . . . communication interface
32 . . . browser unit
32a . . . content reproduction unit
32b . . . metadata analysis unit
32c . . . GUI control unit
33 . . . output interface
34 . . . display unit
35 . . . memory
35a . . . cash unit
36 . . . operation device interface
37 . . . application running unit
38 . . . speaker
71 . . . mobile terminal apparatus
72 . . . personal computer
73 . . . server device
74 . . . dedicated apparatus
81 . . . optical disk
82 . . . cassette tape
83 . . . flexible disk
84 . . . memory card
85 . . . USB memory
86 . . . IC chip
101 . . . communication interface
102 . . . live participant communication unit
102a . . . connection request unit
102b . . . content receiving unit
102c . . . content restructuring unit
102d . . . content distributing unit
103 . . . browser unit
103a . . . broadcast screen generation unit
103b . . . graphic interface control unit
103c . . . manager operation unit
104 . . . operation device interface
105 . . . display unit
106 . . . output interface
107 . . . memory
107a . . . cash unit
108a . . . content restructuring unit
109 . . . broadcast screen delivery unit
110 . . . VoIP unit
111 . . . application running unit
112 . . . voice conversation unit
113 . . . speaker
114 . . . microphone
115 . . . camera
116 . . . image processing unit
221 . . . authentication unit
222 . . . group conversation control unit
222a . . . group creation unit
222b . . . connection managing unit
222c . . . terminal list generation unit
222d . . . node control unit
223 . . . data transmitting unit
223a . . . content delivery unit
224 . . . metadata generation unit
225 . . . content acquisition unit
231 . . . user database
232 . . . group database
233 . . . display information accumulating unit
234 . . . contents information accumulating unit
401 . . . communication interface
402 . . . viewer communication unit
402a . . . connection request unit
402b . . . content receiving unit
402c . . . content restructuring unit
402d . . . content delivery unit
402e . . . connection response unit
403 . . . browser unit
403a . . . content reproduction unit
403b . . . GUI control unit
404 . . . operation device interface
405 . . . display unit
406 . . . output interface
407 . . . memory
407a . . . cash unit
411 . . . application running unit
413 . . . speaker
500 . . . window

What is claimed is:

1. A live broadcast system comprising:
a live participant terminal used by each of particular live participants, provided with an input device which acquires video and audio of the live participant, and configured to receive an operation signal of the live participant;
a live participant communication unit configured to perform a bidirectional call by transmitting and receiving video and audio acquired with the input device on a real time base through a first communication network formed by the live participant terminals;
a graphic interface control unit configured to generate icons designating video and audio transmitted and received during the bidirectional call performed by the live participant communication unit;
a broadcast screen generation unit configured to display the icon in order that the icon can be selected by an operation signal of the live participant, and generate a broadcast screen for outputting video and audio corresponding to each icon in response to a selection operation by the operation signal;
a broadcast screen delivery unit configured to deliver the broadcast screen through a second communication network;
a viewer terminal used by each of predetermined viewers and configured to receive and output the broadcast screen.

2. The live broadcast system of claim 1 further comprising:
a manager terminal configured to control the bidirectional call and delivery through the first communication network and the second communication network, wherein
the broadcast screen generation unit is provided with a manager operation unit configured to control the output of video and audio corresponding to each icon in response to an operation signal from the manager terminal.

3. The live broadcast system of claim 2 further comprising:
a connection managing unit configured to acquire a permission signal from the live participant terminal or the manager terminal, and permit the viewer terminal to connect with the first communication network on the basis of the permission signal which is acquired, wherein
the live participant communication unit is provided with functionality to have the viewer terminal permitted by the connection managing unit participate the bidirectional talk as the live participant terminal.
